(19) United States
(12) Patent Application Publication
(10) Pub. No.: US 2026/0223783 A1
(43) Pub. Date: Aug. 6, 2026

(54) DEVICE AND METHOD FOR PROCESSING PLANTS

(71) Applicant: HYLER BV, Meulebeke (BE)

(72) Inventor: Niels BAERT, Sint-Baafs-Vijve (BE)

(21) Appl. No.: 19/152,994

(22) PCT Filed: Feb. 1, 2024
(86) PCT No.: PCT/IB2024/050939

§ 371 Date: Aug. 1, 2025

(30) Foreign Application Priority Data
Feb. 1, 2023 (BE) 2023/5065

(51) Int. Cl. A01F 15/07; A01F 15/08

(52) U.S. Cl. CPC A01F 15/0705; A01F 15/0833; A01F 15/0883; A01F 2015/077; A01F 2015/0795

(57) ABSTRACT

A rolling unit for forming bales from a stream of plants or parts thereof includes two bounding elements which are arranged opposite each other in a lateral direction for the purpose of bounding a receiving space in the lateral direction, a plurality of radial bounding elements which are configured to bound the receiving space in a radial plane perpendicularly of the lateral direction, and a feed opening defined by one or more of the above stated elements for receiving a stream of plants or parts thereof for the purpose of gradually forming a bale from plants or parts thereof accumulating in the receiving space. The rolling unit further includes adjusting elements for adjusting a lateral distance between the bounding elements and/or a lateral tension on the bounding elements.

This document relates to a rolling unit for forming a bale from a stream of plants or parts thereof, to a method for forming a bale from a stream of plants or parts thereof using such a rolling unit, and to a device for processing plants or parts thereof resting on a ground in one or more swathes using such a rolling unit.

A rolling machine is an agricultural machine for forming bales of determined plant species, particularly fibre plants such as flax, hemp, kenaf, jute and sisal, grown on a field or land. During picking, fibre plant parts which have been picked, i.e. cut loose or pulled loose, are initially placed down onto the ground parallel to each other in rows, also referred to as swathes. These fibre plants are then left on the ground for some time so that a retting process takes place. To enable retting to take place properly and uniformly, the fibre plants on the ground must be turned over at regular intervals. This is done by picking up fibre plants resting on the ground, rotating them through 180 degrees and then placing them back down onto the ground.

When they are placed down onto the ground, the fibre plants are placed one behind the other in long rows, in so-called swathes. The width of the swathes created in this way is determined on one hand by the plant species and on the other by the method used for picking and further processing of the fibre plant parts.

At some point the fibre plant parts will be ready to be taken away. At this time one or more rolling machines are slowly driven over the ground (i.e. the land or the field) in the longitudinal direction of the swathes. The fibre plants are picked up as the rolling machine travels over the ground. The picked-up fibre plants are then transported to a rolling unit of the rolling machine, in which the fibre plants are rolled into an (often cylindrical) bale. Finally, the bale is tied up and then ejected from the rolling machine, and then comes to lie on the ground on the rear side of the machine. More specifically, once a bale has been fully formed, the rolling machine ceases operations and comes to a standstill in order to unload the formed bale from the rolling unit and set it down on the ground.

It is known to make the rolling machine suitable for rolling up and tying up plants of different lengths by installing reducing elements in the receiving space of the rolling machine when short plants must be rolled up and by uninstalling these reducing elements again when long plants must be processed. This installing and uninstalling is however labour-intensive and time-consuming.

It would optionally be possible to adapt the rolling machine in a manner other than by installing a reducing element, for instance by manually making the receiving space larger or smaller before or after use as processing device. This is however likewise labour-intensive and expensive.

Furthermore, the dimensions of the receiving space of the rolling machine in which the (fibre) plants are rolled up during the rolling process can in neither case be modified, and it will therefore not be possible to take into consideration while travelling over the field any varying properties and conditions of the (fibre) plants and/or different stages of the rolling and tying process, as will be elucidated below.

Rolling units of different sizes and forms may be needed subject to the size of the (fibre) plants or parts thereof present on the ground (which size may or may not vary along the swathe), the state and condition of the (fibre) plants during processing (varying humidity and/or temperature, and so on), the stage of the processing process (infeed, rolling, tying, discharging) and to the intended application of the resulting bales. It is even possible that rolling units of a different size and form are needed time and again while travelling over the field. Providing alternative rolling units, modifying a rolling unit with a reducing element and modifying the rolling unit in other manner by manually making the receiving space larger or smaller before or after use as processing device are labour-intensive, inefficient, expensive and/or time-consuming. In the known machines it is not possible either, or insufficiently so, to continue to take into consideration during rolling, while travelling over the ground, varying properties and positions of the (fibre) plants and the swathes in which the (fibre) plants lie on the field.

Finally, it has been found that known rolling machines often exhibit a relatively great loss of seed during processing of the (fibre) plants. The processing undergone by the (fibre) plants is often so rough that the bolls of the (fibre) plants are damaged and/or seed is released from the (fibre) plants and finds its way onto the field again.

There is a need for a better alternative for forming bales in which at least one of the above stated and/or other drawbacks of the prior art is at least partially obviated.

According to a first aspect, at least one of these objects and/or other objects is achieved at least partially in a rolling unit for forming a bale from a stream of (fibre) plants or parts thereof, comprising:
a support frame;
bounding elements arranged on the support frame for bounding a receiving space of variable dimensions, wherein the receiving space is embodied to receive and roll up therein the plants or parts thereof and wherein the bounding elements comprise:
parallel lateral bounding elements arranged at a mutual lateral distance to each other for the purpose of bounding the receiving space in lateral direction; and
one or more radial bounding elements extending substantially in an imaginary peripheral plane for the purpose of bounding the receiving space in radial direction, wherein the radial bounding elements comprise one or more elongate drive elements guided over a plurality of rollers extending laterally between the lateral bounding elements;
wherein the device further comprises a drive for rotatably driving at least one of the rollers for the purpose of advancing the elongate drive elements, wherein the elongate drive elements are arranged in use, when the at least one roller is driven by the drive and the elongate drive elements thereby run, to gradually roll up and form into a bale the plants or parts thereof supplied to the receiving space;
further comprising one or more remotely controllable adjusting elements configured to adjust the lateral position of at least one of the lateral bounding elements.

In determined embodiments the rolling unit is configured to operate the remotely controllable adjusting elements for the purpose of adjusting the mutual lateral distance between the lateral bounding elements. In other embodiments, although the lateral positions of the lateral bounding elements are adjusted, this is done such that their mutual lateral distance remains essentially the same.

Adjusting the lateral position or distance remotely for instance enables the rolling unit to be made suitable in simple manner, from the driver's cab, for rolling up (fibre) plants of different lengths or for rolling up (fibre) plants that find their way to the rolling unit with varying lateral positions of their outer ends. If there are for instance relatively short fibre plants on the field, the mutual distance between the lateral bounding elements will preferably be kept small, while a greater mutual distance will be opted for in the case of relatively long fibre plants. It can further be realized that the mutual distance between the lateral bounding elements is increased at the end of the rolling process, so when the bale is about to reach or has reached its maximum size. This in order to reduce the friction between the lateral bounding elements and the (fibre) plants of the bale and so facilitate and/or speed up outfeed of the bale from the rolling unit and/or to reduce the risk of damage to the rolled-up fibre plants (which may lead to seed loss) during tying and/or discharging.

Said elongate drive elements can comprise flexible strips, chains with slats or, preferably, belts or conveyors. The elongate drive elements are preferably endless drive elements, such as endless conveyors or endless belts. In determined embodiments each of the elongate drive elements forms an endless drive element arranged round said rollers, for instance an endless drive conveyor or endless drive belt.

Although it is possible in principle to make only one of the lateral bounding elements adjustable and therefore mount the other lateral bounding element on the chassis of a vehicle at a fixed position, in determined embodiments each of the remotely controllable adjusting elements is configured to adjust the mutual lateral distance between the lateral bounding elements, and thereby adjustable. In determined embodiments the lateral positions of the bounding elements can be adjusted independently of each other. The adjusting can take place via an optionally centrally arranged control unit, such as a controller (for instance a Programmable Logic Controller (PLC)) or the like, which is connected via a wired or wireless connection to each of the remotely controllable adjusting elements. The control unit can here operate the adjusting elements, manually through an operating person in the driver's cab of the vehicle and/or automatically through the control unit.

The control unit can be configured to synchronously and/or continuously adjust the lateral positions of both lateral bounding elements. Adjusting the positions synchronously (i.e. simultaneously) enables the centre point of the bale to be adjusted in lateral direction or the width of the bale to be varied while the centre point remains the same. In further embodiments the control unit is configured to leave the intermediate distance between the lateral bounding elements unchanged when the lateral positions of both lateral bounding elements are adjusted. Not only are the lateral bounding elements adjusted synchronously (i.e. simultaneously) in these embodiments, this adjustment takes place to the same extent for both lateral bounding elements so that the width of the bale remains the same while the lateral position of the receiving space still changes.

Adjusting the lateral positions of both lateral bounding elements can otherwise be done continuously, so likewise during travel over the ground and/or during rolling of the fibre plants into a bale or during tying of the bale of fibre plants.

In determined embodiments of the invention the control unit is coupled to at least one of an odometer or position determining unit, particularly a GPS, Galileo or Glonass position determining unit, for determining the path travelled by the rolling unit. The control unit is here further configured to displace the lateral bounding elements reciprocally in lateral direction, subject to the determined travelled path. In the case of relatively short fibre plants, this reciprocal displacement of the receiving space provides a bale which is rolled up highly uniformly.

An adjusting element is preferably arranged in the centre of a lateral bounding element. This simplifies making the bounding element rotatable so that it can co-rotate with the rotation of the elongate radial bounding elements. For this same reason, among others, a lateral bounding element is preferably further mounted on the frame with only a single adjusting element. In determined embodiments an adjusting element comprises a linear guide. This linear guide (or linear guides) can be configured to reciprocally guide at least one bounding element. The actuator can be integrated in one or more of these linear guides, but can also take the form of a separate actuator.

In determined embodiments the rolling unit comprises a guide element mounted pivotally on the frame. A number of the above stated rollers is mounted on this guide element. Because the guide element is pivotable, the positions of the rollers mounted thereon, and thereby the local course of the elongate drive elements, can co-displace (i.e. pivot) with the bale which becomes increasingly larger during rolling. In other words, the guide element can be configured to adjust the position of the roller or rollers mounted on the guide element to the radial dimensions of the bale which become increasingly greater during rolling. For the purpose of enlarging, optionally also changing the peripheral form of, the receiving space the pivotable guide element can be configured to move in a radial plane between a respective first position and second position under the pressure of the bale of plants or parts thereof formed gradually in the receiving space. In this way the radial bounding elements are able to properly follow this ever-increasing diameter of the receiving space so that a good and reliable rolling process of the plants is enhanced.

In determined embodiments it may be important to provide technical measures whereby constant tension is kept on the quantity of fibre plants being rolled up, for instance by keeping the endless drive means, such as the conveyors and/or belts, around the plants which are being rolled up with a tension within a limited tension range, or with a substantially constant tension, during rolling. In determined embodiments these technical measures are formed by a suitably embodied guide element. As alternative or in addition thereto, the rolling unit comprises in a further embodiment:
a tensioning element mounted pivotally on the frame and provided with at least one roller for guiding the one or more elongate drive elements; and
a biasing element, such as a spring, mounted pivotally on the tensioning element and the frame, for keeping the one or more elongate drive elements under bias.

The tensioning element ensures that the elongate drive elements are always tensioned, irrespective of the size of the bale and irrespective of the position of the unloading door to be described below.

In embodiments of the invention the rolling unit comprises a dimension measuring unit configured to determine the momentary radial dimension of a bale in the receiving space for the purpose of generating a dimension measurement signal representative of the measured radial dimension of the bale and transmitting it to the control unit. The dimension measuring unit can comprise an angle sensor. This angle sensor can then be configured to measure an angle between said pivotable guide element and the support frame. The measurement signal generated by the dimension measuring unit is then a signal which is representative of the measured angle. The control unit that has received the dimension measurement signal can determine on the basis thereof that a desired maximum bale diameter has been reached. This means that the supply of fibre plant parts to the relevant rolling unit can be halted (by controlling a so-called distributing unit) and that the bale tying process can be started (by placing cords round the bale and by increasing the speed by controlling the drive of the drive elements).

In further embodiments the rolling unit comprises a moisture sensor which is arranged in the receiving space, in a bounding element or in both and is configured to determine the momentary humidity in the receiving space, to generate a humidity signal representative of the measured humidity, and to transmit the humidity signal to the control unit. The control unit can be configured here to control at least one of the adjusting elements on the basis of the humidity signal (as was the case with the dimension measurement signal) in order to change the lateral position of the corresponding lateral bounding element.

In determined embodiments rollers and elongate drive elements are arranged to leave clear a feed opening for receiving the stream of fibre plants or parts thereof in the receiving space.

In determined embodiments each of the adjusting elements comprises a remotely controllable actuator, for example an electric or hydraulic cylinder. Adjusting the lateral distance between the lateral bounding elements then comprises of controlling the force being exerted by at least one of the actuators.

In determined embodiments the rolling unit comprises an unloading door mounted on the support frame via hinges or rotation shafts and pivotable between an opened position and closed position, and an actuator for driving the pivoting between the closed and open position, wherein the hinges or rotation shafts are preferably configured to pivot open the unloading door in upward direction. The hinges or rotation shafts are preferably arranged close to the centre point of the lateral bounding elements, wherein the distance between a hinge or rotation shaft on one side and the centre point of the relevant lateral bounding elements on the other still more preferably amounts to between 10 cm and 50 cm and/or wherein a hinge or rotation shaft of the unloading door is located above the centre point of the relevant lateral bounding elements.

In a particularly advantageous embodiment the unloading door with hinges or rotation shafts is configured to swing aside to the opened position when the unloading door is opened, along a path lying wholly inside the space spanned by the support frame and just outside the effective receiving space.

In determined embodiments the rolling unit comprises a control unit which is connected to adjusting elements of the lateral bounding elements and to an actuator of an unloading door, wherein the control unit is configured to briefly increase the mutual distance between the lateral bounding elements for the purpose of at least partially eliminating any tension which may have built up between the lateral bounding elements and the plants in the receiving space.

In determined embodiments the rolling unit comprises bounding elements which are configured, at least when a bale has been formed, to together bound a receiving space which is drum-like or, more particularly, cylindrical, for the purpose of forming a drum-like/cylindrical bale.

In determined embodiments the rolling unit comprises a housing for enclosing the bounding elements, wherein the housing has a feed opening and an unloading opening.

According to a second aspect, a device is provided for processing plants, particularly fibre plants, the device comprising:
a self-propelling or drawn vehicle comprising a chassis on wheels;
a pick-up unit or a picking unit, wherein the pick-up unit or the picking unit is configured to respectively pick up the fibre plants or parts thereof resting on a ground in one or more swathes or pick plants sticking out of the ground;
one or more rolling units arranged on the chassis as defined here;
a transport unit for transporting the picked-up or picked plants or parts thereof in a stream from the at least one pick-up unit or picking unit, respectively, to at least one of the rolling units.

In determined embodiments the device comprises a control unit configured to reciprocally displace the lateral bounding elements in lateral direction while the vehicle travels over the ground. The intermediate distance between the lateral bounding elements can here optionally remain the same.

The device can comprise at least two rolling units, wherein each of the at least two rolling units is configured to form bales with essentially the same dimensions, wherein each of the at least two rolling units is preferably embodied identically to the other rolling units.

According to a third aspect, a method is provided for forming a bale from a stream of fibre plants or parts thereof by means of the rolling unit defined here, the method comprising of:
receiving a stream of fibre plants or parts thereof in the receiving space via a feed opening defined by the elongate drive elements;
driving the rollers in order to run the elongate drive elements, herein rolling up the fibre plants or parts thereof received in the receiving space; and
unloading a formed bale of fibre plants or parts thereof from the rolling unit;
further comprising of operating one or more of the remotely controllable adjusting elements at least one of before receiving and rolling up the stream of plants, during rolling of the plants or after rolling of the plants for the purpose of adjusting the lateral position of at least one of the lateral bounding elements.

The method can particularly comprise of adjusting the lateral positions of the lateral bounding elements and/or mutual lateral distance between the lateral bounding elements during rolling. In determined embodiments the adjusting of the positions of both lateral bounding elements comprises of keeping the mutual distance between the lateral bounding elements substantially the same, while in other embodiments the mutual distance is conversely varied.

The method preferably comprises of adjusting the lateral dimensions of the receiving space by adjusting the lateral distance between the bounding elements.

The method preferably comprises of adjusting the radial dimensions of the receiving space by adjusting the radial positions of the radial bounding elements, for instance by adjusting the radial positions of one or more of the rollers and the elongate drive elements guided thereover.

The method preferably comprises of having one or more of the rollers move under pressure of the bale of fibre plants or parts thereof gradually forming in the receiving space for the purpose of increasing the receiving space and optionally changing the form of the receiving space in the radial plane.

The method preferably comprises of measuring the size, the pressure produced and/or the weight of the gradually formed bale of fibre plants or parts thereof while receiving a stream of fibre plants or parts thereof in the receiving space; and of not unloading the formed bale until a predetermined size, a predetermined produced pressure and/or a predetermined weight is reached.

The method preferably comprises of reducing a lateral tension on the formed bale and/or wrapping the formed bale with tying materials, for instance cords, prior to unloading the formed bale.

The method preferably comprises of reducing a lateral tension on the formed bale by reducing a lateral tension on the bounding elements, during unloading of the formed bale.

The method preferably comprises of unloading a formed bale of fibre plants or parts thereof from the rolling unit by displacing an unloading door on which at least a part of the rollers is mounted, for the purpose of forming an unloading opening.

Further advantages, features and details of the invention will be elucidated with reference to the following description of some embodiments thereof. Reference is made in the description to the accompanying figures.

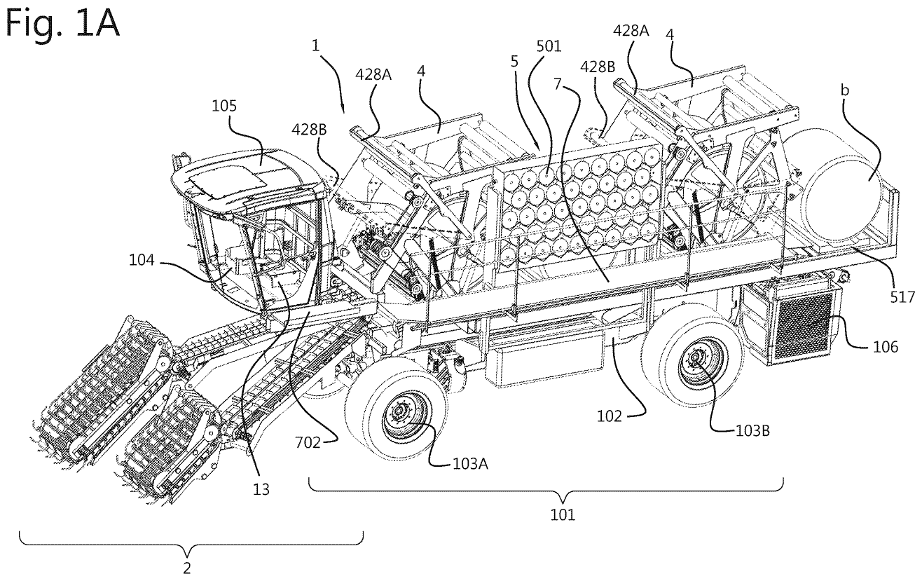

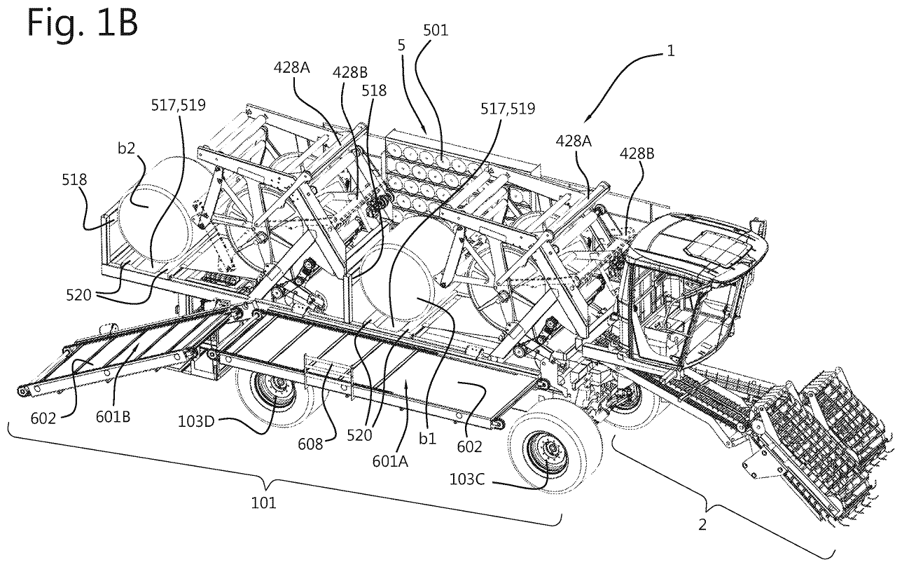

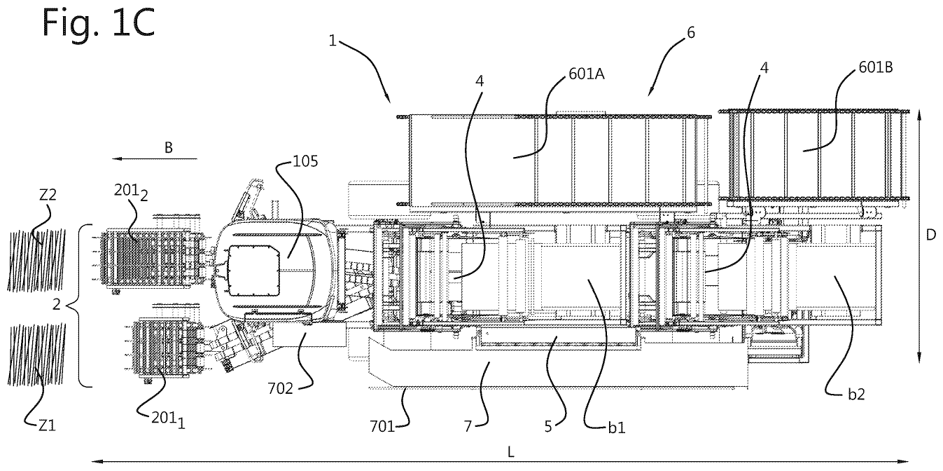

FIG. 1A shows a perspective side view of the left-hand side of the first embodiment of the device, in which determined elements, such as protective elements and the like, have been omitted for the sake of clarity.

FIG. 1B shows a partially cut-away perspective side view of the right-hand side of the first embodiment of FIG. 1A.

FIG. 1C shows a top view of the first embodiment of FIGS. 1A and 1B.

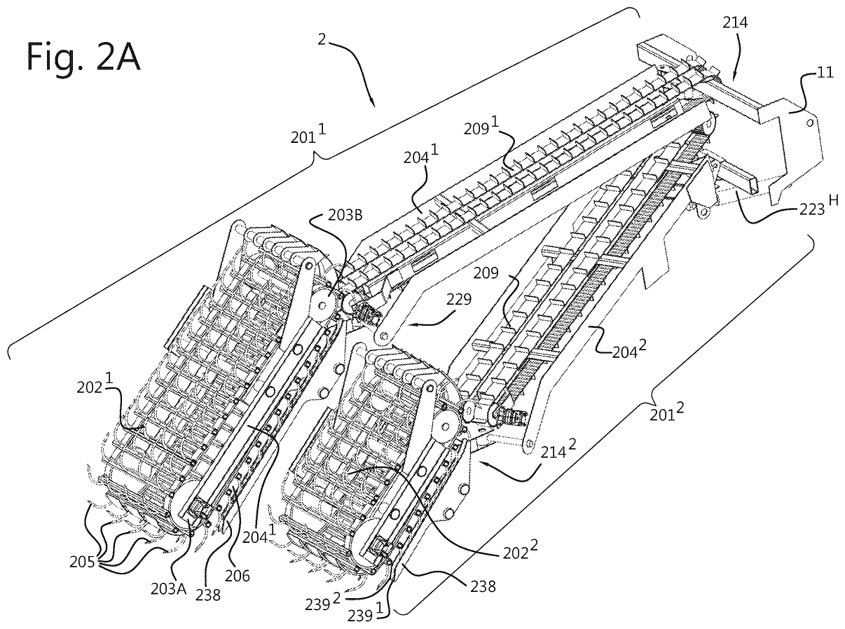

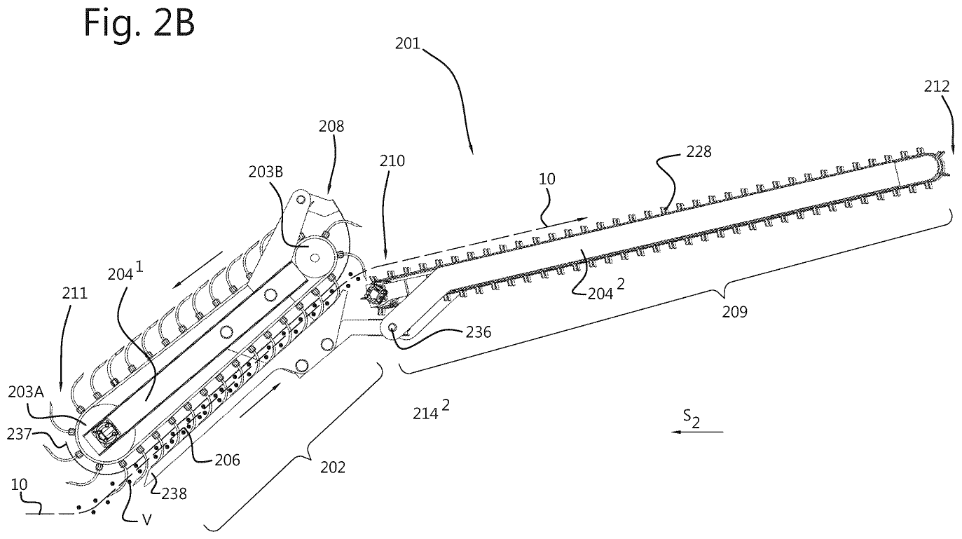

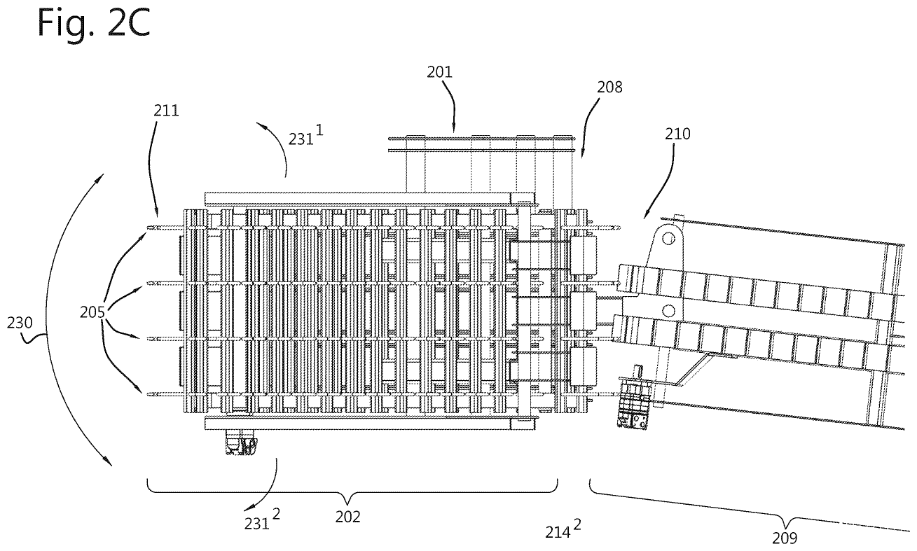

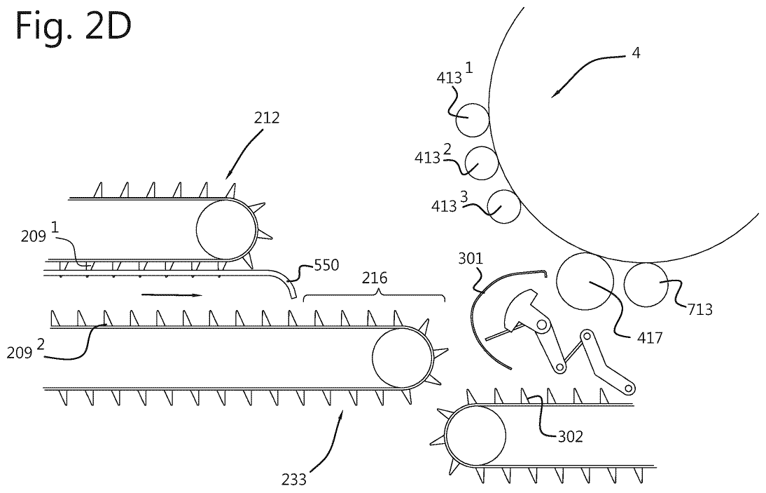

FIGS. 2A-2D show a pick-up unit and individual pick-up arms according to an embodiment, wherein 2D also represents the combination with the distributing unit for distributing the supplied stream of fibre plants.

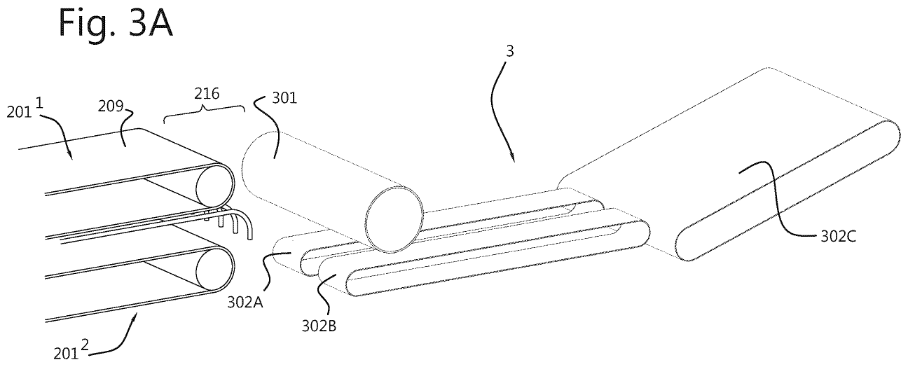

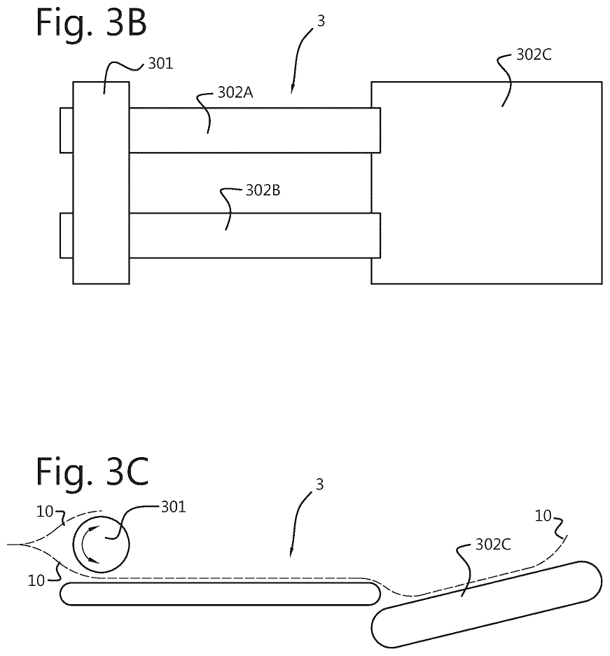

FIG. 3A shows schematically a side view of an outer end of two pick-up arms, a distributing unit and a transport unit according to an embodiment.

FIGS. 3B and 3C show schematically a top view and side view of an embodiment of a distributing unit with transport unit.

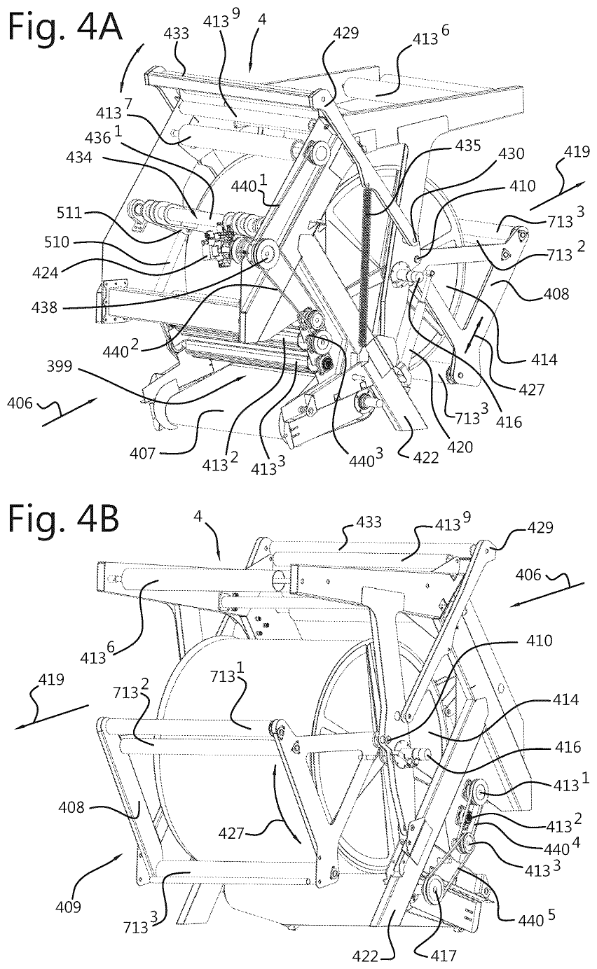

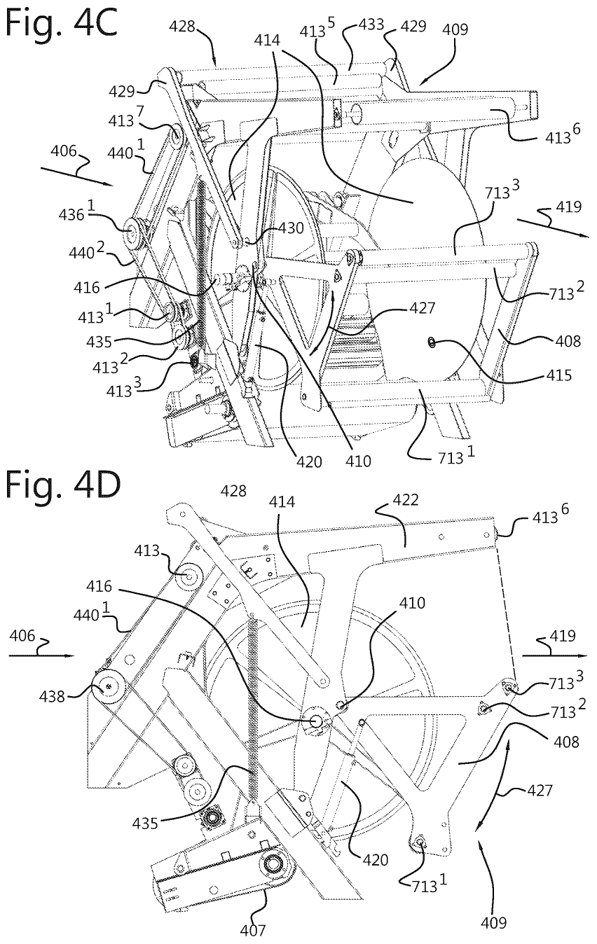

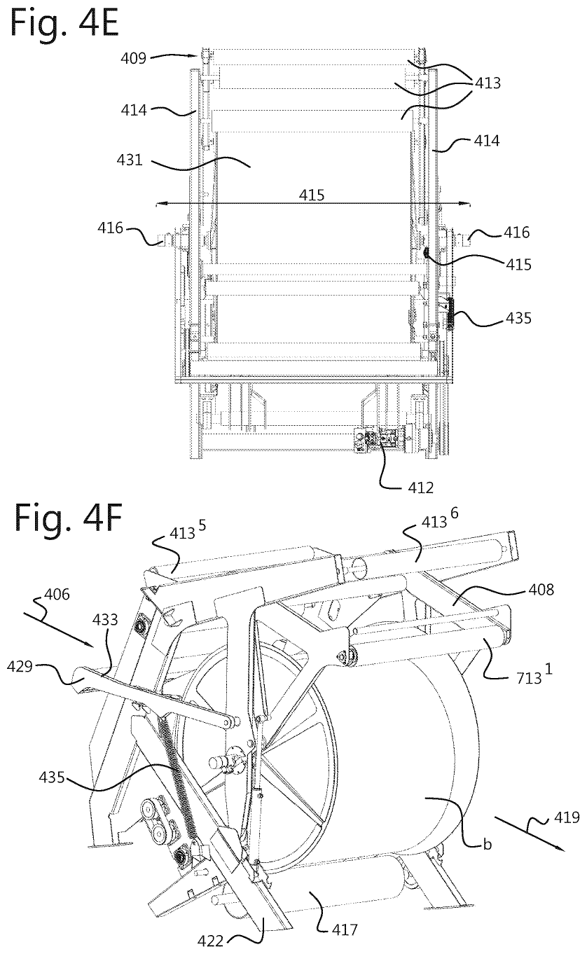

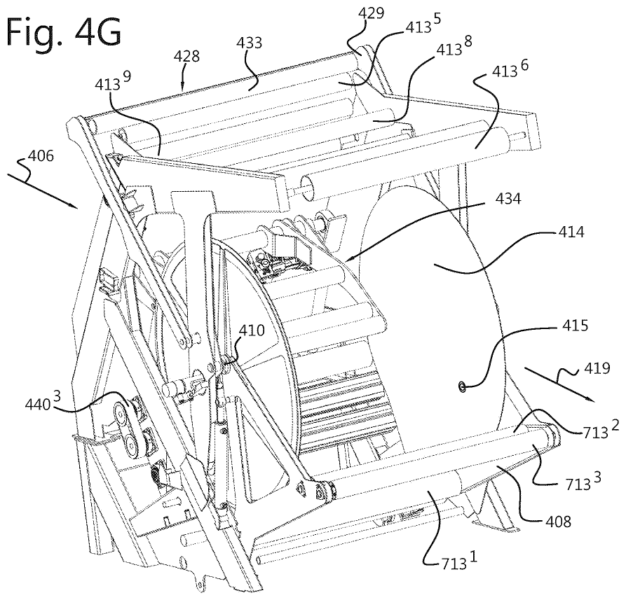

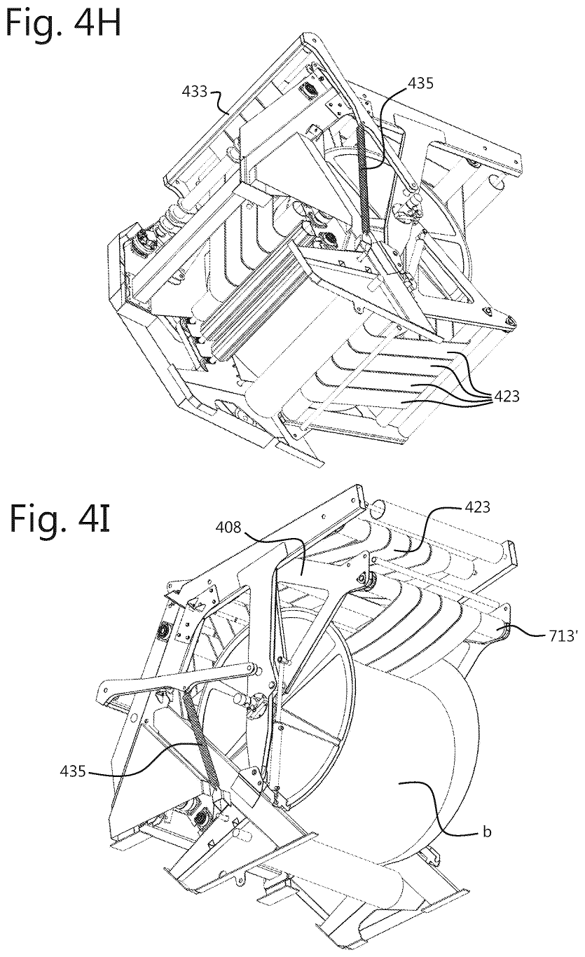

FIGS. 4A-4G and FIGS. 4H and 4I show a rolling unit according to a first and second embodiment, respectively without and with (a part of the) rolling belts, wherein the unloading door is opened in FIG. 4H and the unloading door is closed in FIG. 4I.

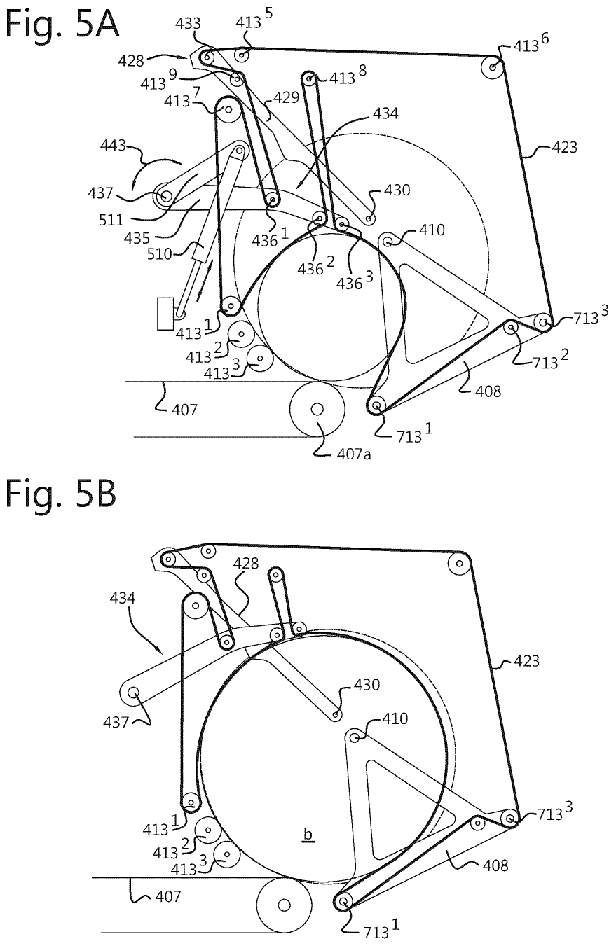

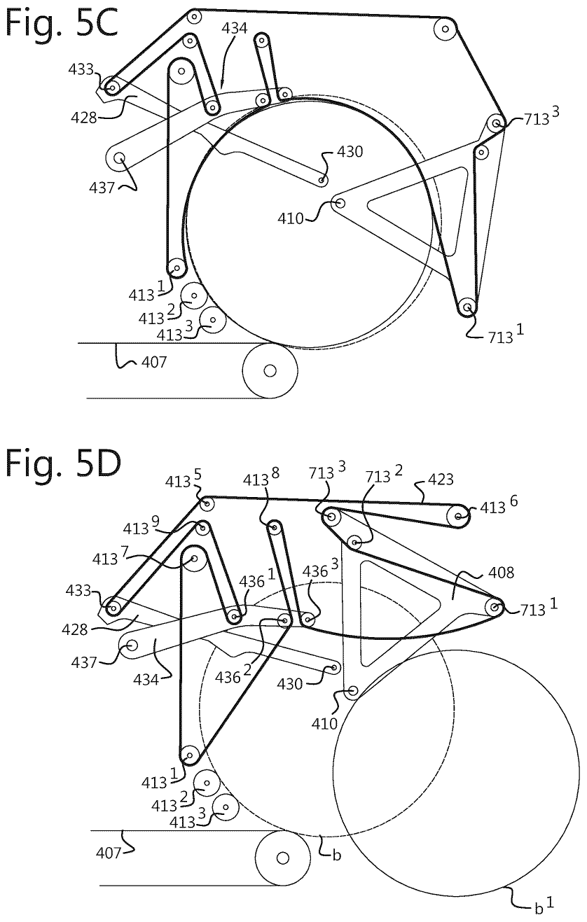

FIGS. 5A-5D show schematically how fibre plants are rolled up in a rolling unit, in each case during a further stage of the rolling process.

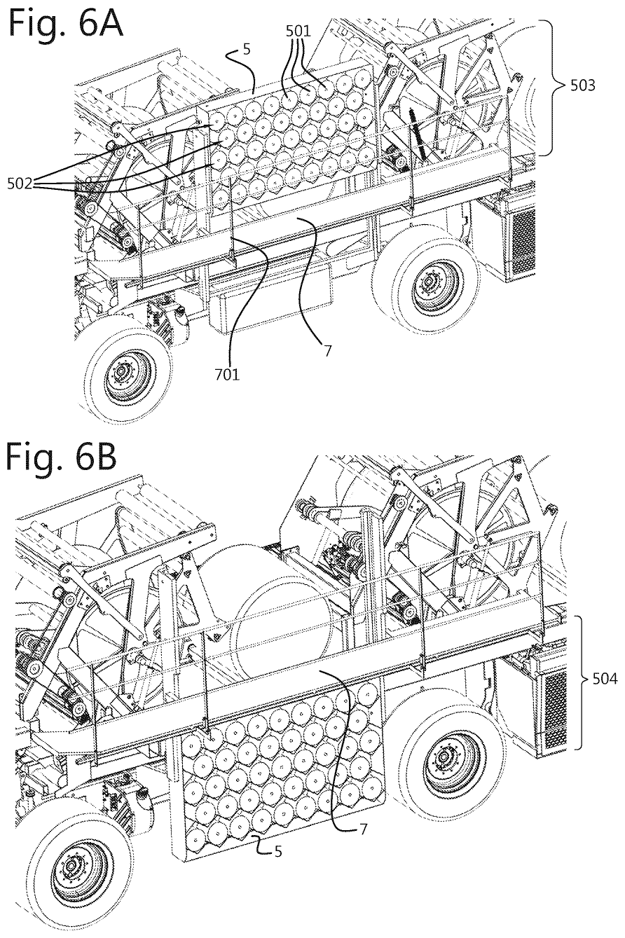

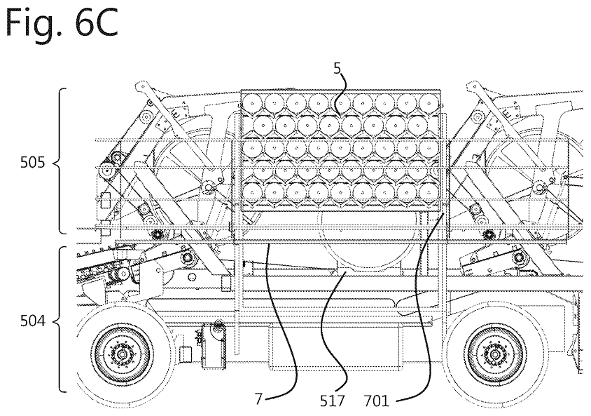

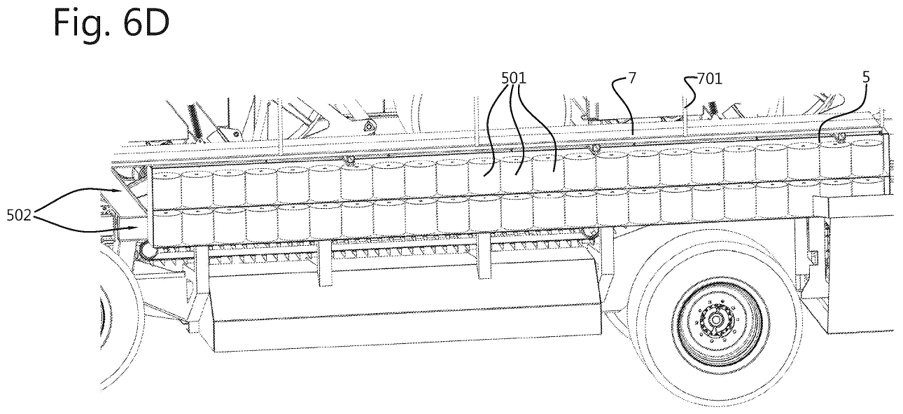

FIGS. 6A-6D show a tying material storage unit and man platform according to a first embodiment. FIG. 6D shows a tying material storage unit and man platform according to a second embodiment.

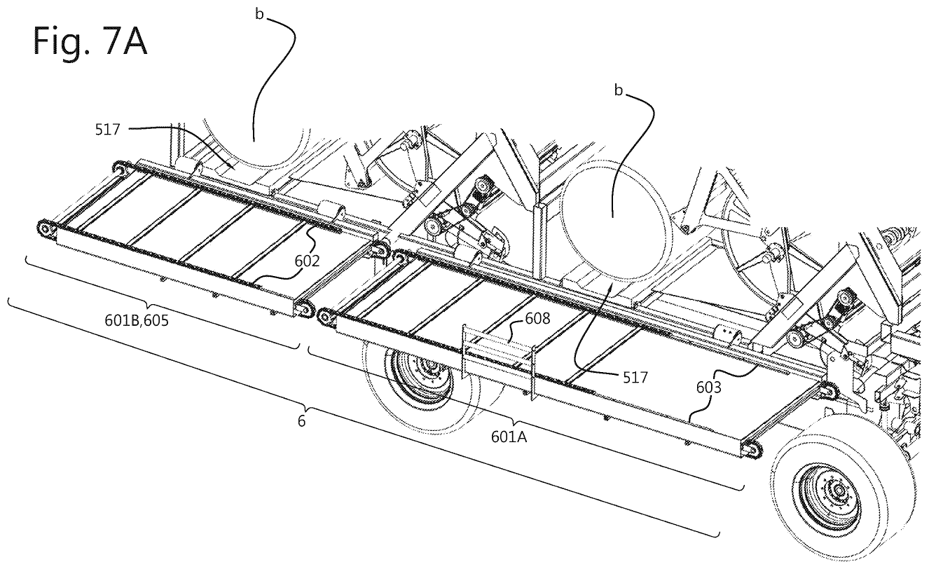

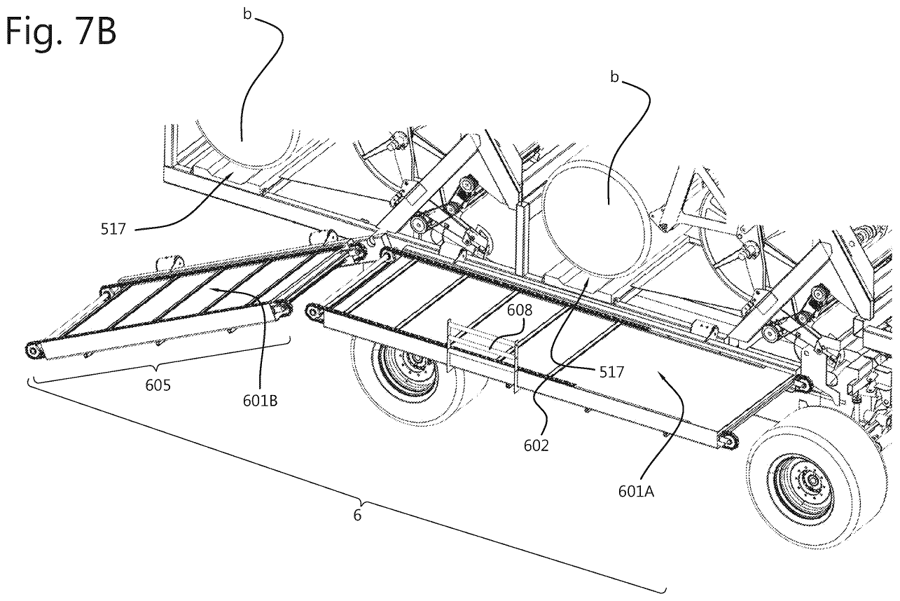

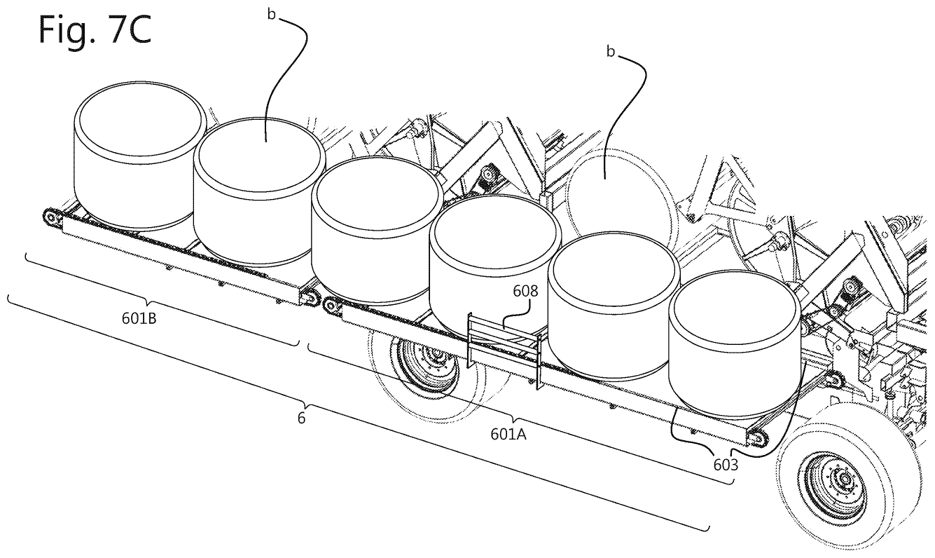

FIGS. 7A-7C show a bale storage unit for bales according to an embodiment.

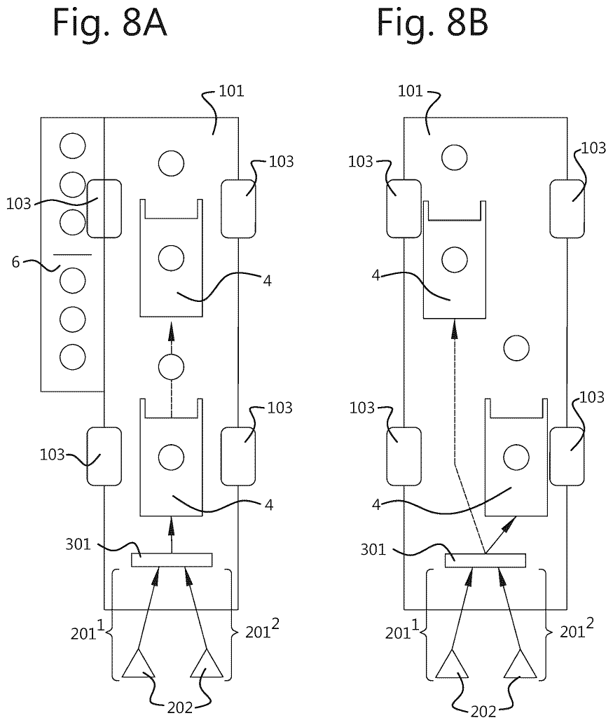

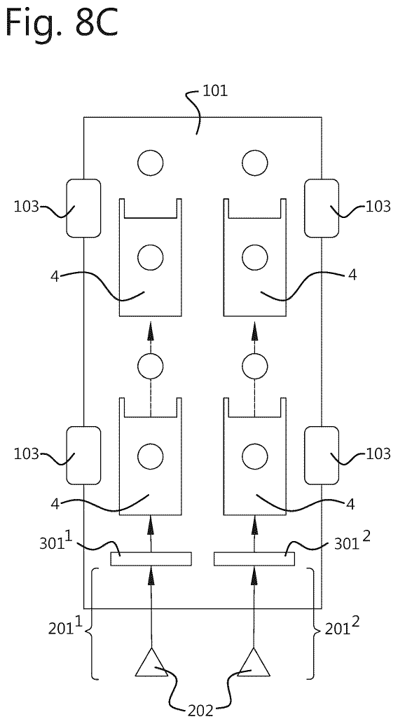

FIGS. 8A-8C shows schematically different possible placements of rolling units on a device.

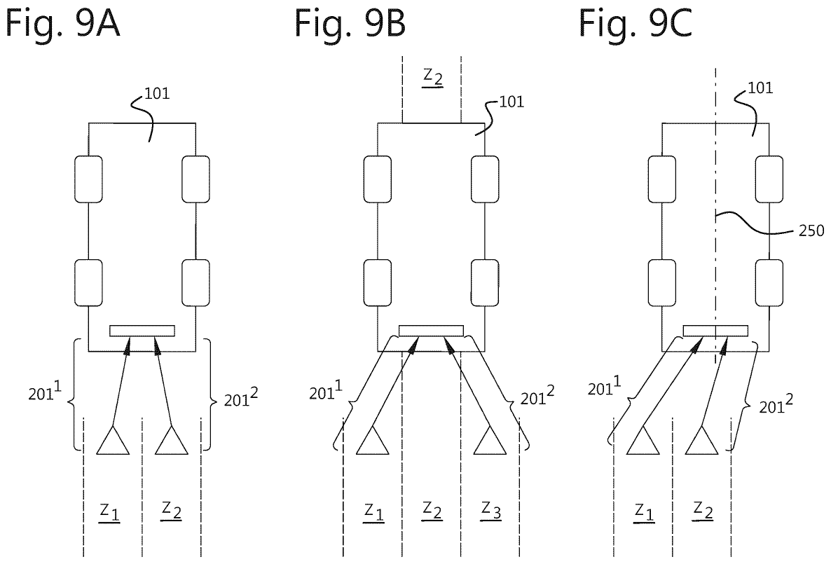

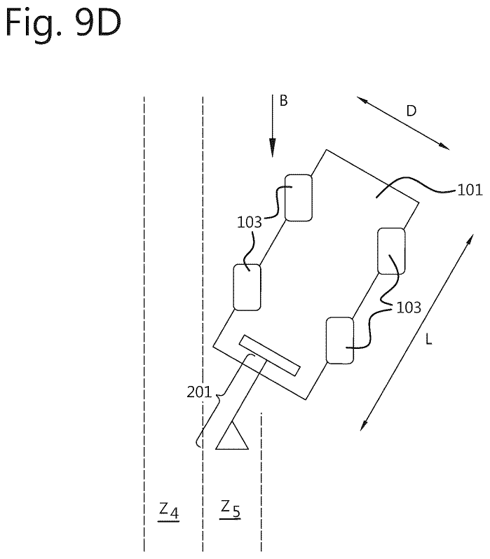

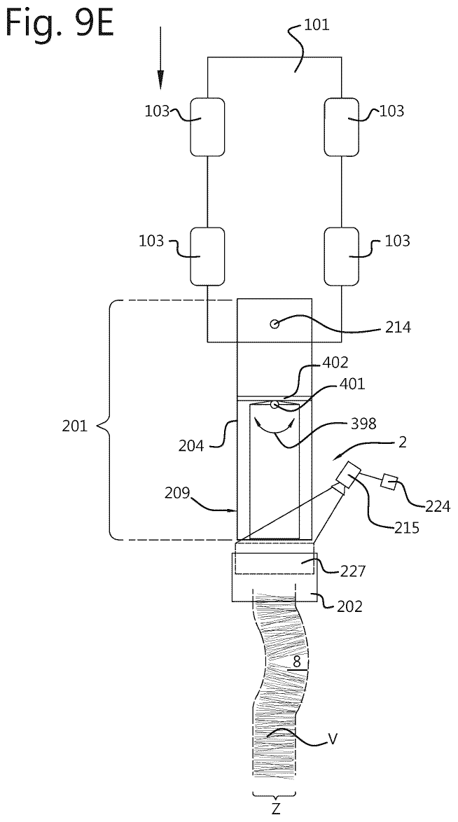

FIGS. 9A-9E shows schematically different possible pick-up angles and angles of travel of a device. FIG. 8E shows an embodiment of a device comprising an observation unit.

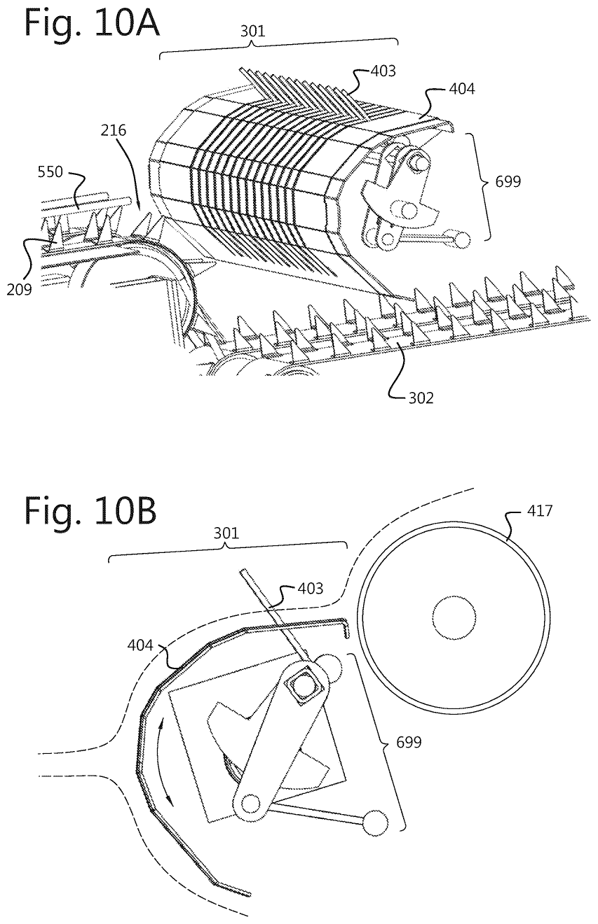

FIGS. 10A-10B show a distributing unit according to an embodiment.

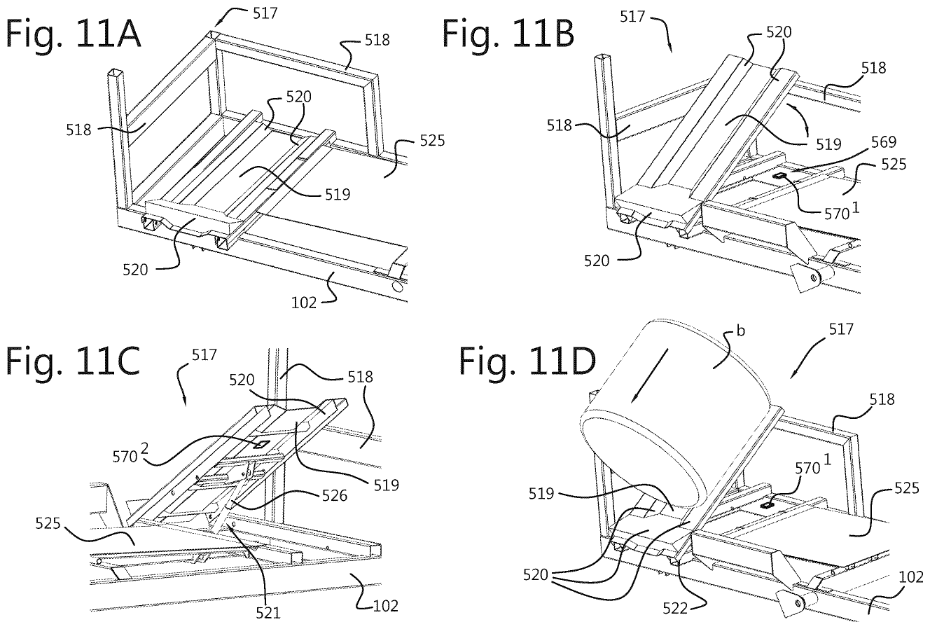

FIGS. 11A-11D show an embodiment of a discharge unit.

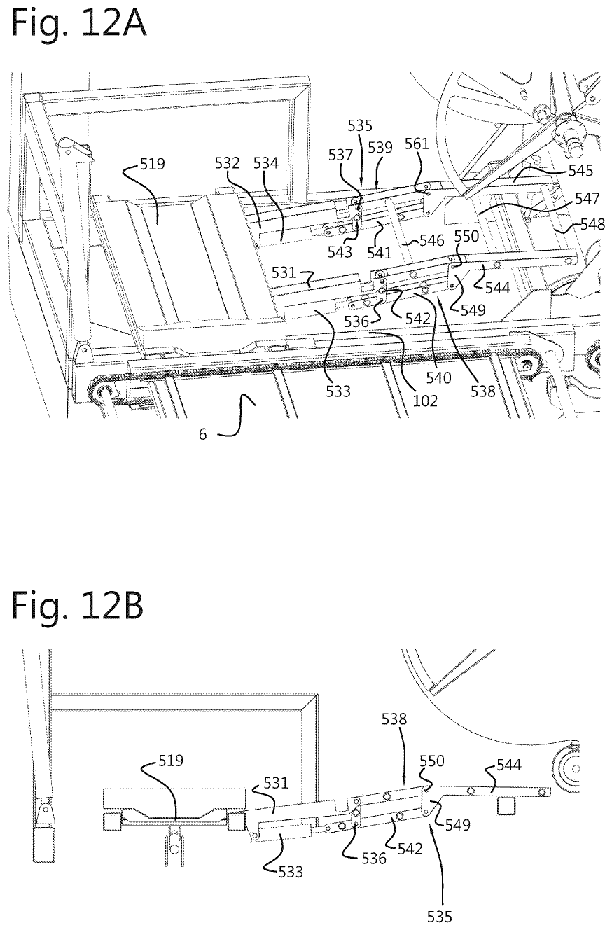

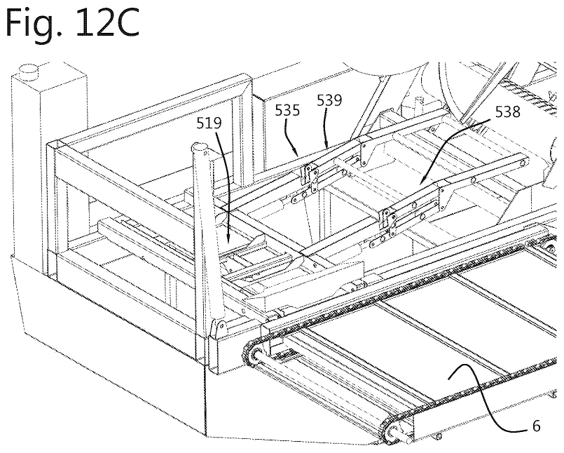

FIGS. 12A-12C show views of an embodiment of a rolling unit provided with both an ejecting unit and a discharge unit, wherein a part of the discharge unit has been omitted for the sake of clarity of the drawing and all figures show the ejecting unit in downward position.

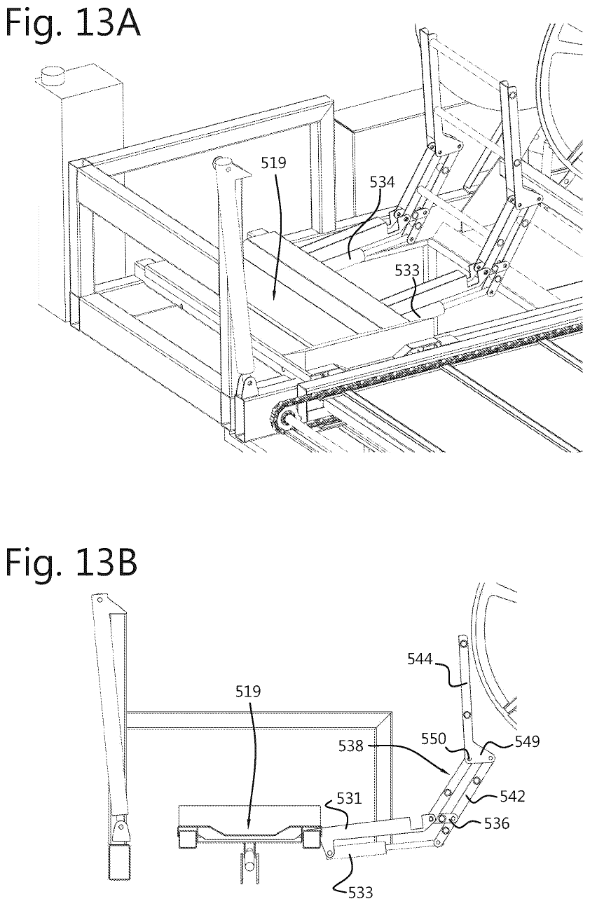

FIGS. 13A-13B show (partially cut-away) views of the embodiment of FIGS. 12A-12C, with the ejecting unit in an upward folded position.

FIGS. 12A-11D show an ejecting unit according to a determined embodiment.

FIGS. 13A-13C show a third embodiment of the invention, wherein FIG. 13A shows a side view (left-hand side), FIG. 13B shows a partially cut-away side view (right-hand side), and FIG. 13C shows a top view.

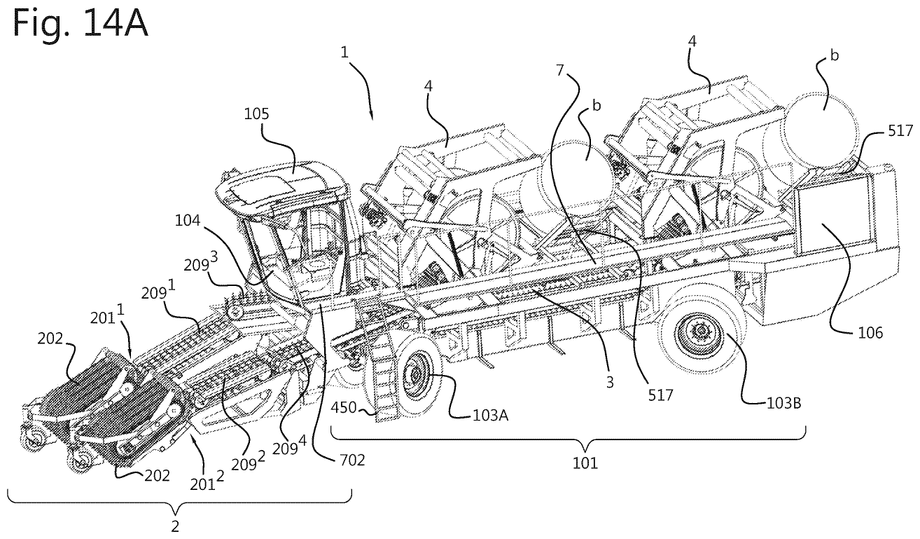

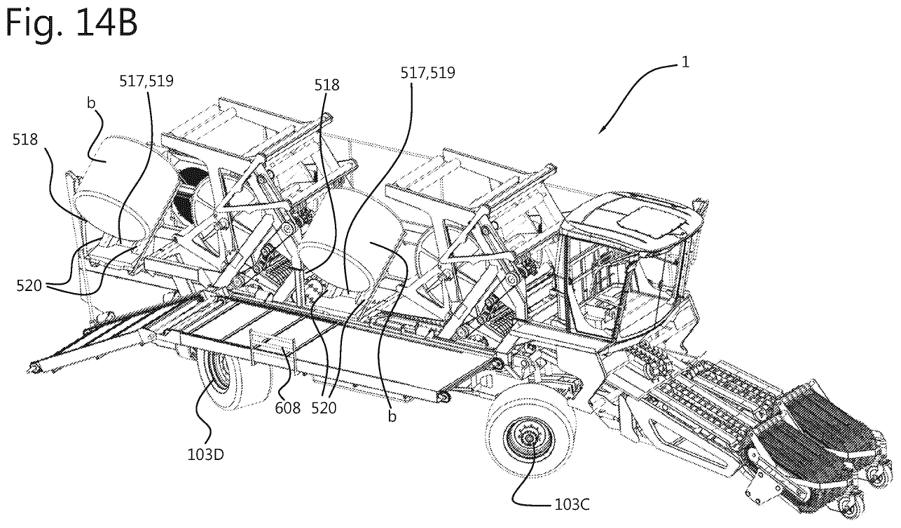

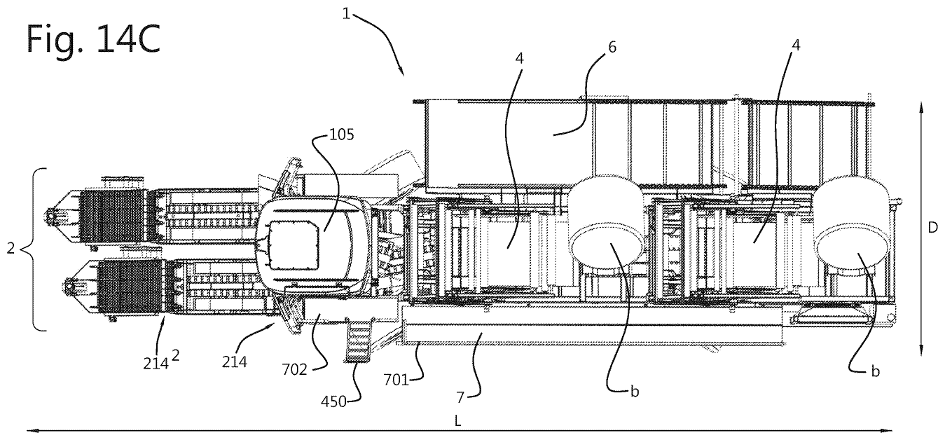

FIGS. 14A-14C show a perspective side view of a second embodiment of a device in which determined elements, such as protective elements and the like, have been omitted for the sake of clarity.

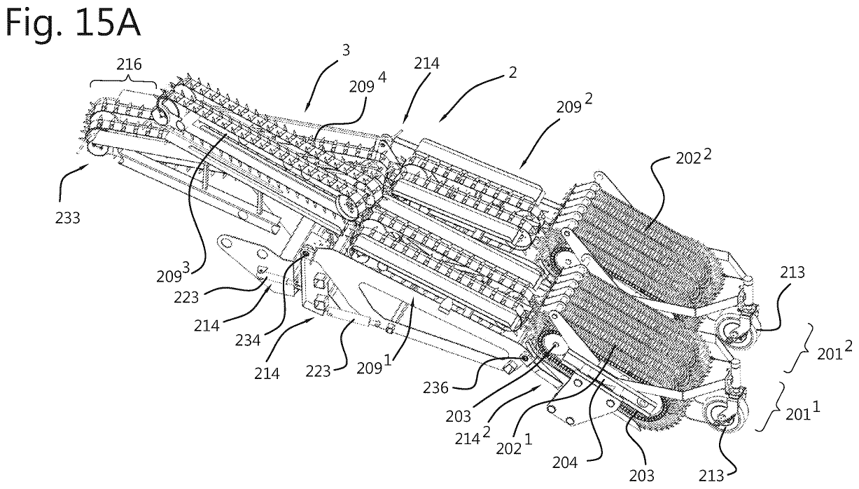

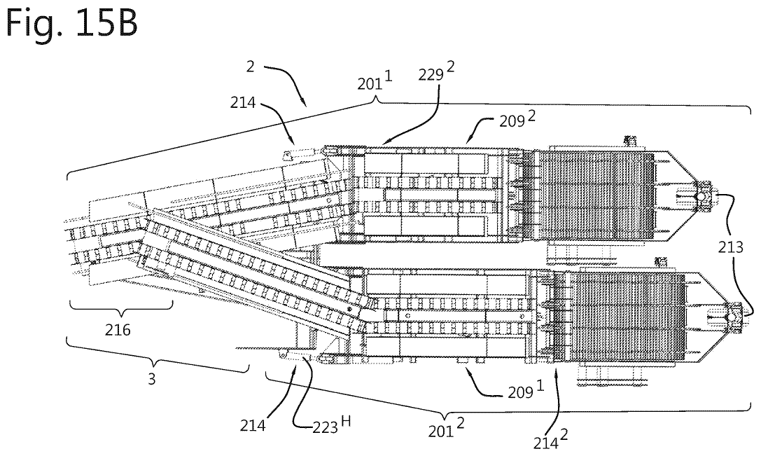

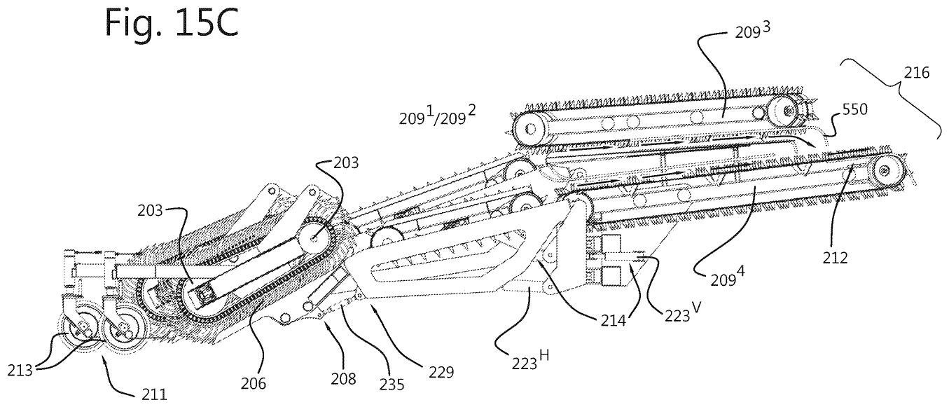

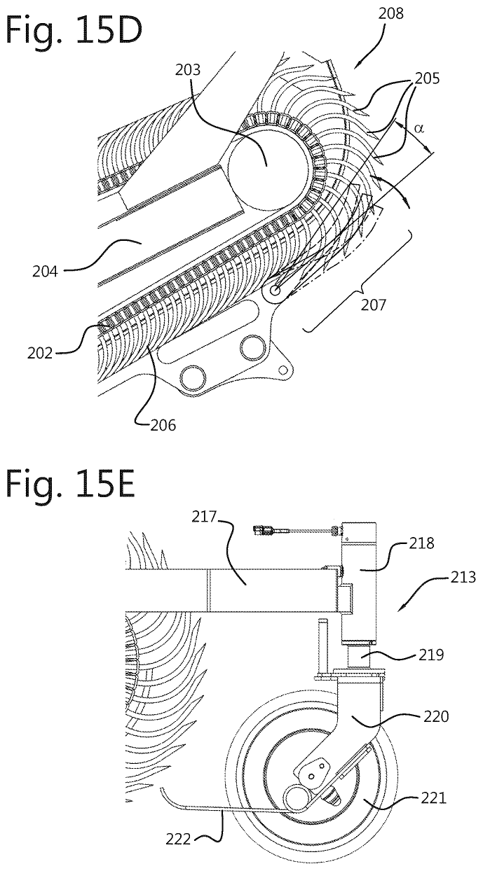

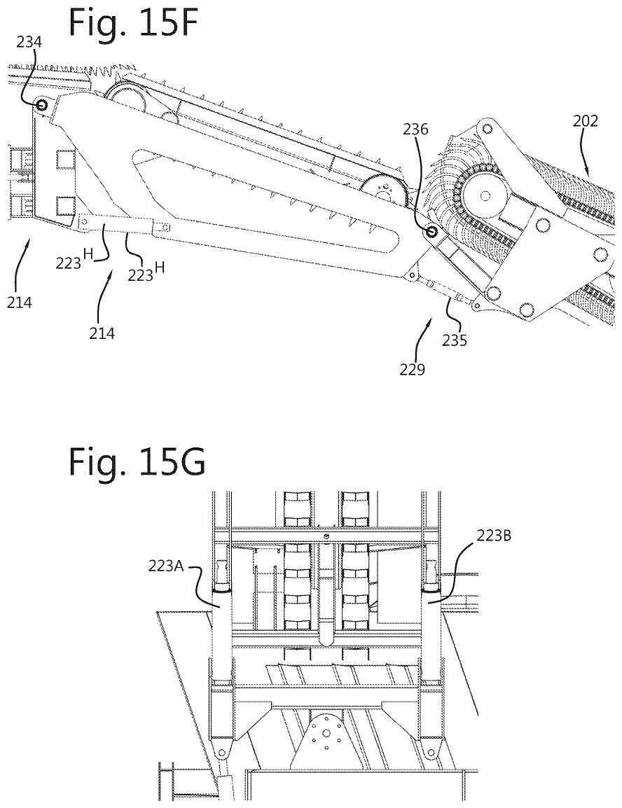

FIGS. 15A-15H show various views of a further embodiment of a pick-up unit according to the invention. More specifically, FIGS. 15A-15C show respectively a view diagonally from the side, a top view and a side view of this embodiment, and FIGS. 15D-15G show various detail views of embodiment details of the pick-up unit according to this further embodiment. FIG. 15H shows a detail view of the pivot point and the actuator whereby the pick-up arm of FIGS. 15A-15G can be pivoted reciprocally in lateral direction (i.e. in transverse direction).

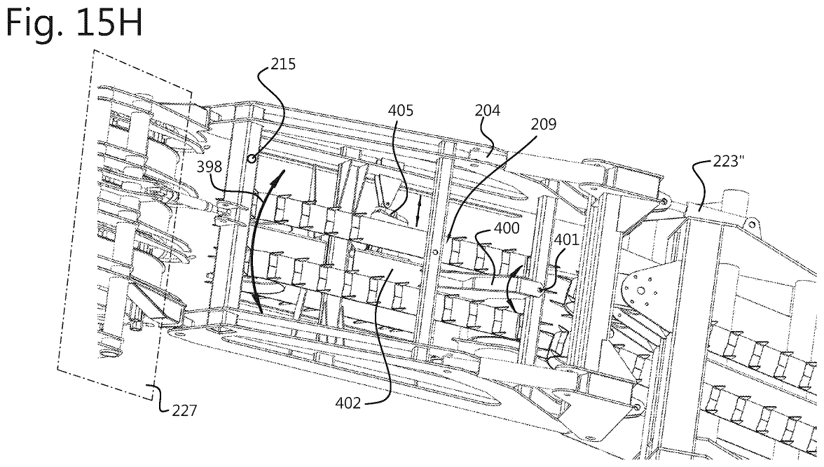

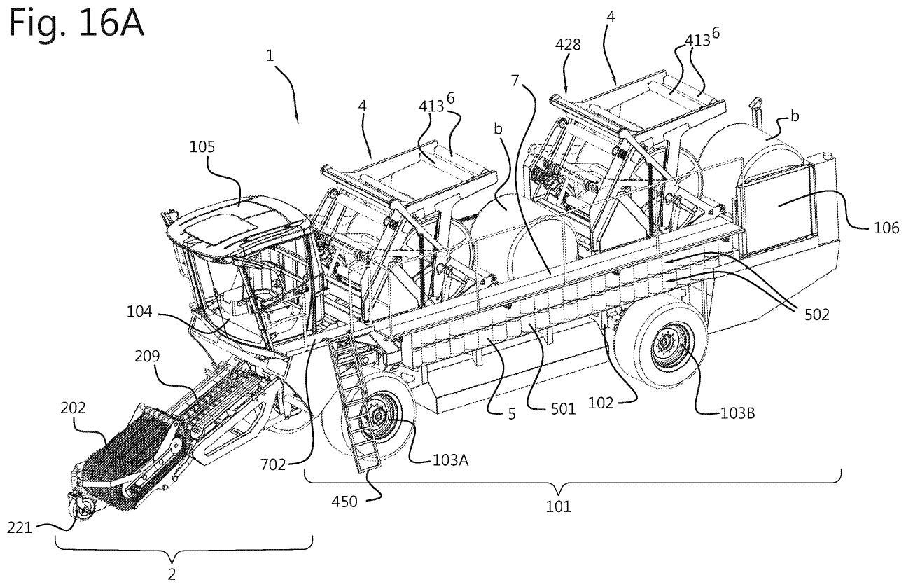

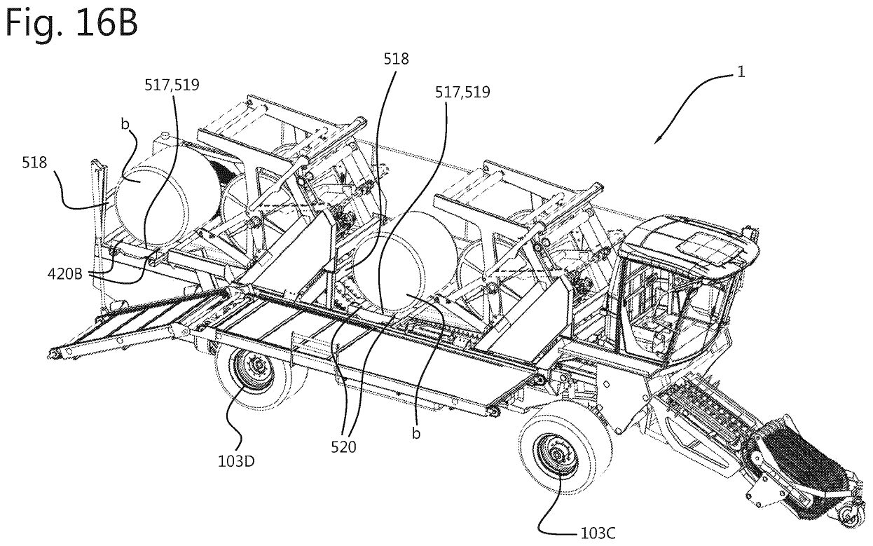

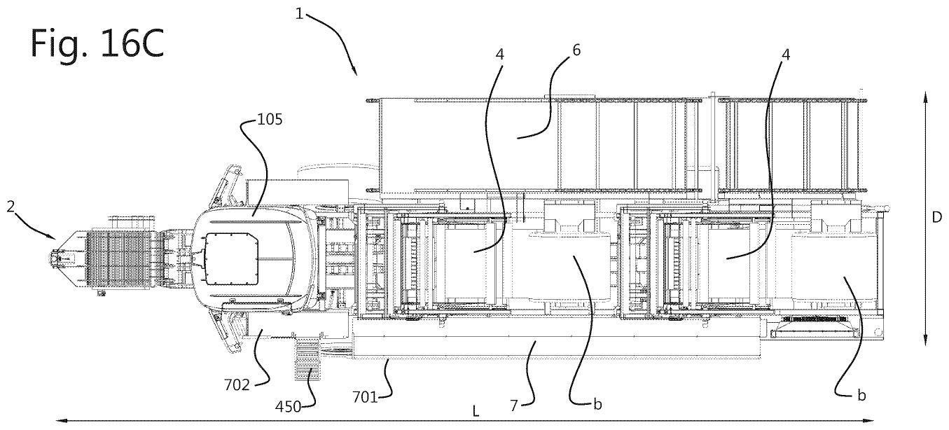

FIGS. 16A-16C show a third embodiment of a device.

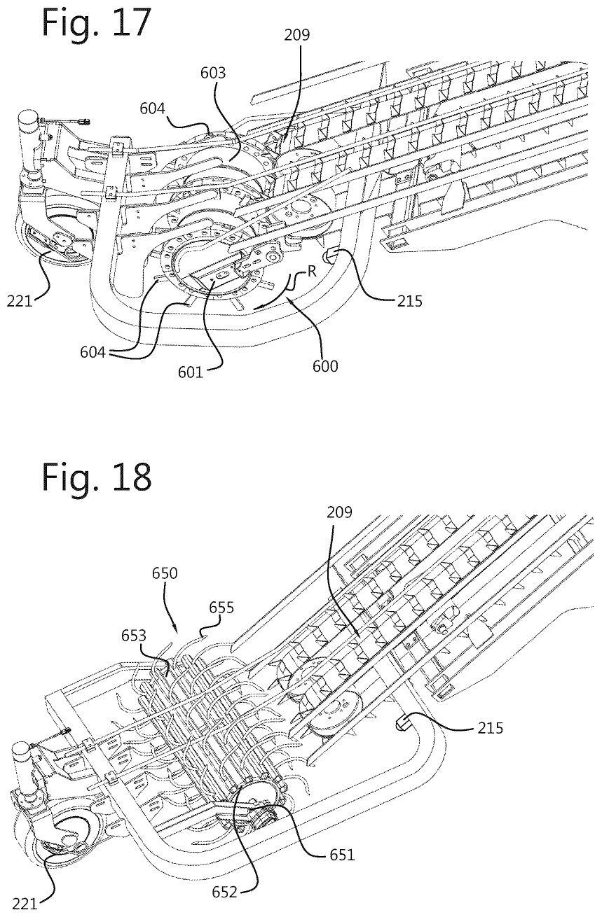

FIG. 17 is a perspective view of a further embodiment of a pick-up arm, provided with a pick-up drum.

FIG. 18 is a perspective view of a further embodiment of pick-up arm, provided with a sun gear.

The device 1 according to the present application is particularly suitable for processing (i.e. picking up, rolling into bales, storing of bales, placing bales onto the ground, and so on) of fibre plants or parts thereof. Examples of fibre plants are flax, hemp, kenaf, jute and sisal. The device can in principle however also be applied to process crops in general, these not necessarily being fibre plants, such as straw.

Flax is a fibre crop that is cultivated for making linen, among other things. The flax plant is usually between 80 and 120 cm long, and is harvested using a drawn or self-propelling flax picking machine. For this purpose the flax picking machine has on the front side a picking unit embodied specifically to pull the flax plants from the ground. The harvested flax plants are then processed by the flax picking machine by displacing them to the rear side of the flax picking machine and placing the flax plants on the ground during travel. The flax plants are placed flat on the ground in long rows, also referred to as “swathes”, wherein the stems of the harvested flax plants extend substantially transversely of the longitudinal direction of the swathes. This placing back of the flax flat onto the ground so that said swathes are created is also referred to as “depositing” or “picking up”. When the flax plants are placed in swathes or rows, an intermediate space is left between adjacent swathes. These spaces are provided in order to prevent the swathes from becoming tangled in each other.

The harvested flax plants which were placed flat on the ground in swathes are then retted under the influence of a combination of at least one of dew, rain, sunlight and moisture/heat rising from the ground. The retting of the flax by leaving the flax plants on the ground (i.e. a field or retting field) for some time is referred to in the field of processing flax as field retting or dew retting. In order to obtain a uniform retting and to prevent rotting of the flax, the flax placed flat on the ground in rows must be flipped over regularly. This flipping over of the flax placed flat on the ground is also referred to as “turning”. The turning of the flax is performed using a drawn or self-propelling flax turner.

Hemp is likewise a fibre crop that is cultivated for making inter alia textile fabrics, rope, and for many other uses. The flax plant is usually between 80 and 120 cm long. The hemp plant is a lot longer than the flax plant. The hemp plant is characteristically between 140 cm and 240 cm in length (although in the case of less successful sowing where the hemp plant has more space to grow, a length can be much greater, for instance 320 cm or more). The hemp is usually cut at the base of the hemp plant and then processed further.

Fibre plants consist of different fibre plant parts, for instance stems, leaves, roots and bolls. Depending on the further processing for which the plants are harvested, it may be preferred to obtain a mixture of fibre plant parts with a determined quality, i.e. to have as many as possible of determined fibre plant parts and conversely as few as possible of others in the resulting mixture.

When harvesting, hemp plants are sometimes cut into two roughly equal parts, a top part and bottom part. The two parts then comprise a mutually differing composition of types of fibre plant part. The length of the resulting parts is roughly the same as the length of a picked flax plant, for instance between 70 cm and 120 cm. When depositing hemp, kenaf, sisal or jute, swathes of top parts and swathes of bottom parts come to lie alternatingly on the field, which swathes can picked up by the same type of machine as swathes of picked flax plants owing to their similar length.

FIGS. 1A, 1B and 1C are different perspective overview drawings of a device 1 according to a first embodiment. FIGS. 13A-13C are perspective overview drawings of a device 1 according to a second embodiment, and FIGS. 15A-15C are overview drawings of a device 1 according to a third embodiment.

The device 1 is a processing device for fibre plants or parts thereof. In the figures a pick-up and rolling machine is in each case illustrated as processing device, although many features, for instance features relating to the vehicle or to the pick-up unit, can apply correspondingly (whether or not after a suitable modification) to other types of processing device, such as picking devices configured to pick the fibre plants or turning devices for picking up already picked (and preferably retted) fibre plants, turning the picked-up fibre plants and putting these fibre plants back down onto the ground (field) in inverted position.

The device 1 can take the form of a single vehicle 101 on which several storage and/or processing units are provided. The vehicle 101 then comprises a vehicle chassis 102 on which a number of wheels 103, for instance two or more front wheels 103A, 103C and two or more rear wheels 103B, 103D, with tyres is arranged in a known manner. Vehicle 101 is generally self-propelling, which means that this vehicle 101 is provided with its own drive motor 106 whereby a number of the wheels 103, for instance the rear wheels, or all the wheels 103 of vehicle 101, can be driven. The drive 106 can be arranged on vehicle 101 on the rear side. The drive 106 can be a drive motor, for instance an electric motor or a combustion engine such as a diesel engine, which drives at least the rear wheels 103B, 103D in known manner. In determined embodiments the drive 106 is however formed by a hydraulic drive. Such a hydraulic drive can for instance be a drive which is described in the Belgian patent publication BE1028420A1. Such a drive comprises a number of hydraulic drive motors, for instance a hydraulic drive motor for each of the front wheels 103A, 103C and each of the rear wheels 103B, 103D which is powered from a hydraulic system (not shown) arranged centrally on the vehicle. In determined embodiments each of the wheels 103A-103D is individually driveable (so that each wheel can turn at its own speed) and/or it is not only the front wheels 103A, 103C that are pivotable, but also the rear wheels 103B, 103D. This pivoting of the front and/or rear wheels can likewise be realized in hydraulic manner. More generally, the hydraulic system can further be embodied to supply hydraulic medium for other components of the self-propelling vehicle, for instance for the rolling units, and/or for components mounted on the self-propelling vehicle, such as the transport members of a pick-up unit.

The width of the vehicle 101 (i.e. the dimensions of the vehicle in lateral direction D, see FIG. 1C) is preferably such that in determined countries, for instance Belgium, France or the Netherlands, it is permitted to drive on the public highway at determined speeds, for instance a maximum of 3 metres. The wheels 103 of vehicle 101 are arranged on the outer side of vehicle 101, as seen in the transverse direction D (see FIG. 1C). The width of the footprint of vehicle 101 is therefore a maximum of 3 metres. In order to limit the width of vehicle 101 (for instance to bring the overall width of the whole to a maximum of 2.55 m in determined countries, including France, so that travel can take place at a relatively high speed, for instance 40 km/hour, in compliance with legal requirements) determined storage and/or processing units of device 1 located on the side of vehicle 101 can be arranged in upward-folding manner, as will be described below.

The wheels 103A-103D of vehicle 101 are preferably configured such that they can be individually driven at their own speed and/or can be controlled individually, so that crabbing motion is possible in vehicle 101. Crabbing motion, also referred to as crab steering, is a special type of active multi-wheel steering wherein the direction of movement B does not correspond with the longitudinal direction L in which vehicle chassis 102 is oriented. See in this respect the arrangement of FIG. 9D, to be described below. In this description the “front” of the device is generally understood to mean the front in the direction of movement B, which may differ from the front or front side of the vehicle chassis.

Crab steering can used when a vehicle 101 must travel in a straight line but at an angle, and/or when the rear wheels 103 must not follow the front wheel tracks, for instance in order to alleviate soil compaction. Crab steering works by steering all wheels 103A-103D in the same direction and at the same angle. For this, it is important that at least each set of mutually adjacent wheels 103 can be controlled and driven independently.

Referring to FIGS. 1A-1C, the processing device 1 comprises several storage and/or processing units. These units can be provided on the self-propelling vehicle 101 itself and/or can be arranged on the chassis 102 of the self-propelling vehicle 101 in releasable manner. Such storage and/or processing units can for instance comprise at least one of a pick-up unit 2 configured to pick up from the ground fibre plants lying on the ground side by side in one or more more or less mutually parallel swathes (z₁, z₂, see FIG. 1C) of fibre plants which were picked at an earlier stage and placed down on the ground, a transport unit 3 configured to transport fibre plants over the self-propelling vehicle, one or more rolling units 4 configured to roll the fibre plants transported through the transport unit into bales (b, for instance bales b₁, b₂, . . . bₙ), a bale storage unit 6 for bales (b) formed by the rolling units, a tying material storage unit 5 configured for storage of the necessary tying materials for the bales, one or more discharge units 517 configured to discharge a quantity of fibre plants rolled into a bale from a rolling unit 4 to the bale storage unit 6, and optionally upward folding accessibility aids 7, 701, 702 for persons for the purpose of supplying or removing materials and/or for the purpose of maintenance, repairs and assembly.

Device 1 can be steered and controlled. This can be done by a person present on device 1 during travel and work. The steering and control units 104 required for this purpose can be provided in a driver's cab 105 from which the vehicle 101 can be steered and from which the different storage and/or processing units of device 1 can be controlled. This driver's cab 105 is preferably arranged at a high position on the front of the device, this position giving the driver a good view in the direction of movement B (also referred to herein as direction of travel) and of the pick-up process.

FIG. 1A shows schematically that the self-propelling vehicle is provided with a central control unit 13, also referred to here as a controller, particularly a Programmable Logic Controller (PLC), for instance in the form of a computer, which is in wired and/or wireless connection with the units of the processing device for controlling, including for instance (various components of) the wheel steering, the drive motors of the wheels, the pick-up unit, the transport unit, the rolling units, discharge units and so on.

Alternatively, the device can take the form of a self-propelling vehicle pulling along another vehicle, for instance a tractor with trailer. The other vehicle will then not be self-propelling, and may or may not be steerable. Some of the processing units can then be provided on or at the self-propelling vehicle, and some on or at the vehicle pulled along.

### Pick-Up Unit—General

FIGS. 2A-2D show further details of a pick-up unit 2 according to an embodiment of the invention. The pick-up unit comprises one or more pick-up arms 201 mountable on vehicle 101 for pivoting in lateral direction. These pick-up arms are mounted with their rear side on chassis 102 of the vehicle and rest with their front side on the ground, at least when they are in the operative state. In determined embodiments to be described below the pick-up arms are foldable in upward direction into a transport state. In this latter state the free outer ends of the pick-up arms are located some distance above the ground so that the device is able to move more easily, for instance during transport over the public highway. There are further embodiments in which the pick-up arms are supported on their front side by a support wheel. This support wheel is preferably embodied such that the height of said outer end of the pick-up arm relative to the ground is adjustable.

In the embodiment of FIGS. 2A-2D the pick-up unit 2 comprises two individual pick-up arms 201¹ and 201². The construction of the two pick-up arms largely corresponds, and for the sake of simplicity the construction of only one of the pick-up arms will be described here. It is noted that in other embodiments there is only one single pick-up arm. This single pick-up arm can then be essentially identical to one of the pick-up arms 201¹ or 201² described here.

The pick-up arms 201¹ and 201² are mountable on the chassis 102 of vehicle 101 in releasable manner using mounting means 11. These mounting means 11 are preferably combined with one or more pivoting units 214. In determined embodiments each of the pick-up arms 201¹ and 201² has its own pivoting unit, while in other embodiments the two (or more) pick-up arms 201¹, 201² have a single, shared pivoting unit 214. A pivoting unit is configured to allow the relevant pick-up arm or pick-up arms to be pivotable in up/downward direction and/or in lateral directions. In determined embodiments the mounting means 11 are combined with the one or more pivoting units 214, while in other embodiments the mounting means 11 and pivoting units 214 are embodied separately. The one or more pivoting units 214 comprise a number of actuators 223^{H}, 223^{V}, such as hydraulic extending cylinders, which are attached on one side to chassis 102 and on the other to each of the pick-up arms so that the position of the two pick-up arms relative to the longitudinal axis of the vehicle can be adjusted, more particularly pivoted, in substantially lateral direction (by means of actuators 223^{H}) and/or in substantially up and downward direction (by means of actuators 223^{V}). For the pivoting in up and downward direction use is for instance made of the hinges designated with reference numeral 234 in FIG. 15A. In determined embodiments the pivoting units 214 are intended to move the relevant pick-up arm into a desired position, for instance into a transport position (with the pick-up arms pivoted upward) to enable the vehicle to be displaced rapidly and safely over the ground (for instance the public highway or at the end of a row of fibre plants), or into an operative position in which the vehicle is ready to start processing the fibre plants. In these embodiments the intention is in principle not to adjust the position once in the operational stage, while driving over the field to be worked and processing the fibre plants. In other embodiments the position of a pick-up arm can also be adjusted while driving over the field.

In the embodiments shown in at least FIGS. 1 and 2 the pick-up unit 2 mounted on the front of vehicle 101 has two pick-up arms which are configured to pick up the fibre plant parts of a respective swathe (z₁, z₂, see for instance FIG. 9A). In the shown embodiment each pick-up arm 201 comprises a pick-up element, particularly an endless transport member 202 (also referred to here in determined embodiments as a pick-up belt), and in endless continued transport member 209 (also referred to here in determined embodiments as conveyor belt). In the shown embodiments the endless transport members are formed by respective endless conveyor belts, although other embodiments are also possible. The endless transport member 202 and/or the endless continued transport member 209 of each of the arms is preferably embodied such that its speed can be adjusted independently of the speed of the self-propelling vehicle, and this adjustment of the speed can preferably take place while device 1 travels over the ground. In determined embodiments the endless transport member 202 and the endless continued transport member 209 are embodied such that their speeds can be controlled independently of each other, for instance by the above mentioned central control unit (controller) 13. The pick-up arms 201 can all be embodied in essentially the same way, as described below, and can all have the same length or have different lengths. In many embodiments the lengths will differ from each other. If the fibre plants of adjacent swathes were to unexpectedly overlap to some extent and lie slightly on top of each other after all, the length difference ensures that the fibre plants of an upper swathe will be picked up first, and only then are the remaining fibre plants picked up.

When two or more pick-up arms are applied, the streams of picked-up fibre plant parts must be collected and combined at some point and transported on to one of the rolling units in a single, combined stream. Referring to FIG. 2D, it is shown that the outer end 212 of endless transport member 209¹ of first pick-up arm 201¹ lying close to the vehicle is positioned above the part of second endless transport member 209² of second arm 201² lying closest to the vehicle. Fibre plants picked up and transported by the first pick-up arm 201¹ come to lie on said outer end part of the second endless transport member 209² of the second pick-up arm 201² under the influence of the force of gravity (and guided here by a number of curved guide rails 550). Said outer ends of the first and second pick-up arms thereby form a combining unit 233 and the area of the second guide member on which the fibre plant parts from the first pick-up arm come to lie thus forms a collecting area 216 on which all fibre plant parts to be rolled up come to lie. The thus collected fibre plant parts then find their way to a distributing unit 301 provided on the vehicle. The distributing unit 301 (see for instance FIG. 2D) is configured to receive the supplied stream of fibre plant parts and selectively redirect it to a rolling unit 4 selected from the collection of rolling units arranged on the vehicle. The distributing unit 301 can guide the fibre plant parts directly to a rolling unit 4 (i.e. the first rolling unit located nearest to the pick-up arms), for instance by sending the fibre plant parts in upward direction to the conveyor roller 417 (FIG. 2D) of rolling unit 4 (as will elucidated further below) or can guide the fibre plant parts in indirect manner to a rolling unit 4 lying further away (i.e. a second or still further rolling unit 4 situated at a greater distance) by urging the fibre plants downward with the distributing unit 301 and placing them on the conveyor 302 (or conveyors, in the case of two conveyors lying adjacently of each other, wherein the conveyor can for instance comprise one or more driven, endless conveyor belts) arranged on vehicle 101.

In FIGS. 14A-14C, and particularly FIG. 14B, as well as in FIGS. 15A-15H further embodiments are shown in which the pick-up unit has two separate pick-up arms 201¹ and 201². The two pick-up arms 201¹ and 201² each comprise an endless transport member 202¹, 202² and a respective endless continued transport member 209¹ and 209². As elucidated below, in determined embodiments each of the endless continued transport members 209¹ and 209², or at least a part thereof, can be displaced in lateral directions (i.e. to the left and to the right) in optionally continuous manner (on the basis of image signals of the swathe in front of the vehicle) in order to enable a variation in the swathe to be picked up to be readily accommodated. In determined embodiments (as option, see FIG. 14A) pick-up unit 2 can comprise a further endless continued transport member 209³ and 209⁴. The further continued transport members 209³ and 209⁴ can be mounted fixedly on the chassis 102 of self-propelling vehicle 101 (and therefore form part of the vehicle) or form part of the relevant pick-up arm 201¹, 201¹. Instead of two separate pick-up arms 201¹ and 201² a single pick-up arm 201² can be mounted in these embodiments as well. It is further noted that the term “mounted fixedly” also includes an embodiment in which the one or more pick-up arms are releasable from vehicle 101 using keys.

The pick-up arms of the embodiment of FIGS. 14A-14C and 15A-15H can further also be mounted pivotally to vehicle 101 via one or more pivoting units 214. Using the pivoting unit 214 the pick-up arms 201¹ and 201² can in determined embodiments be pivoted individually or collectively in lateral directions (also referred to here as the horizontal directions), for instance to set the angle between the longitudinal direction of the relevant pick-up arm and the longitudinal direction of vehicle 101 to a value optimal for processing of the fibre plants, and/or be adjusted in up/downward direction.

Besides the pivoting units 214 for pivoting the whole pick-up unit 2 relative to vehicle 101, shown in embodiments of FIGS. 1, 2, 14 and 15, pick-up unit 2 can be provided with one or more sets of further pivoting units for pivoting one or more components of a pick-up arm 201¹, 201² relative to one or more other components thereof.

FIGS. 2A-2B, 14A-14C, 15A-15H for instance show that the endless conveyor member 202¹, 202² of each of the pick-up arms 201¹, 201² is also pivotable via hinges 236 relative to the corresponding endless continued transport member 209¹, 209². The pivoting is realized by one or more pivoting units 214². In the shown embodiment the endless transport member 202¹, 202² is embodied for pivoting in up and downward direction only. For driving the pivoting movement the pivoting unit 214² comprises inter alia a number of actuators 235, such as hydraulic or electric extending cylinders (for instance FIG. 15C).

In still further embodiments at least one (preferably each) of the endless continued transport members 209¹, 209² is also embodied such that the relevant transport member can pivot reciprocally in lateral directions relative to the relevant frame 204. In other words, instead of or in addition to the possibility that the whole frame with all components mounted thereon can be pivoted reciprocally, in these further embodiments the endless continued transport member 209¹, 209² can be pivoted reciprocally independently of the corresponding frame 204¹, 204². Such a pivotability can be realized in each of the embodiments of the pick-up arm described here.

FIG. 15H shows a specific manner of implementing the pivotability of the endless continued transport member 209¹, 209². The endless transport member 209 (i.e. 209¹/209²) supports on a sub-frame 402, which sub-frame 402 is in turn mounted via a support 400 and a pivoting element 401 on the (main) frame 204. This makes it possible to reciprocally pivot the endless transport member 209 (in lateral directions, see double arrow 398). The pivoting movement can be driven by an actuator 405 mounted in transverse direction, for example a hydraulic or electric extending cylinder. Because only the endless transport member 209¹, 209² is pivotable instead of the whole frame 204¹, 204² with endless transport member 209¹, 209², much faster reciprocal pivoting is possible. This has the advantage, among others, that any variations in the swathe while the vehicle travels over the field can be followed more rapidly and accurately. Further advantages will become apparent on the basis of the description of FIG. 9E.

In the embodiments described up to this point the endless transport members 202¹, 202² and the further endless transport members 209¹-209⁴ are configured to transport fibre plants in essentially the same position. If the fibre plants are in a lying position at the start of a transport member, they will be kept in the same lying position during transport. In determined further embodiments one or more of the endless transport members can however be embodied such that, during transport in the direction of the vehicle, the position of the fibre plants changes. It is for instance possible to reverse the position of the fibre plants wholly or partially, in other words to rotate the fibre plants through about 180 degrees. In determined embodiments one or more of the conveyors (particularly one or more of the endless transport members) comprises for this purpose an inverting conveyor, particularly a inverting belt or turning belt, which gradually turns over the fibre plants during transport so that the orientation of the fibre plants has been reversed at the end of the relevant pick-up arm. While at the start of a pick-up arm the base of a fibre plant is for instance located on the left-hand side of a determined pick-up arm, at the opposite outer end of the pick-up arm the base of this same fibre plant is located on the right-hand side of the relevant pick-up arm. When there are for instance two pick-up arms for providing two streams of fibre plant parts, and when the two streams are combined, it is hereby possible to have the base ends of the fibre plants and the top ends of the fibre plants rest on each other as desired (if desired) by turning over the fibre plant parts from one of the pick-up arms. It will be apparent that both in embodiments in which the fibre plants or fibre plant parts are not rotated (for instance in the case of relatively short fibre plant parts such as flax), in embodiments in which the fibre plants or fibre plant parts are all rotated, and in embodiments in which one of the streams of fibre plants or fibre plant parts is in each case rotated (for instance in the case of relatively long fibre plants which are cut into two fibre plant parts, wherein the fibre plant parts are transported in separate streams) it is possible to achieve a good alignment of the fibre plants/fibre plant parts of different streams before they are provided to for instance a rolling unit.

In embodiments of the invention each of the pick-up arms comprises a regular conveyor for transporting the plants or plant parts. Instead of or in addition to one or more of such regular conveyors the device can also comprise one or more inverting conveyors. An inverting conveyor is configured to turn the plants over during transport. In a determined embodiment the device comprises for instance a first conveyor configured to transport first plants or plant parts in substantially unaltered position and a second conveyor configured to invert the position of second plants or plant parts during transport.

Both in embodiments in which the device comprises at least one regular conveyor and at least one inverting conveyor and in embodiments in which there are only regular conveyors (or only inverting conveyors) can the different streams of transported plants or fibre plants be processed further on the vehicle separately of each other. It is for instance possible to separately and simultaneously pick up, transport and roll into separate bales two mutually adjacent swathes (a first swathe for instance containing the base end and a second swathe containing for instance a top end). When the fibre plant parts of the first swathe are for instance of a higher quality than the fibre plant parts of the second swathe, a bale with plant parts of a higher quality and a bale with plant parts of a lower quality can thus be realized. In other embodiments the different streams are however combined before being processed further (for instance being rolled into bales). The device is then for instance embodied with a combining unit configured to combine first and second plant parts coming from different conveyors. The plant parts from different (inverting) conveyors can here be placed on top of each other in unaltered position, although in determined embodiments it is also possible to opt to place the first plant parts in an original position and second plant parts in a reversed position on top of each other, for instance the first outer ends of the first plant parts on the second, opposite outer ends of the second plant parts, by guiding the first plant parts through a (regular) conveyor and the second plant parts through an inverting conveyor before providing them to a combining unit.

In determined embodiments it is possible that the outer end on the discharge side of the first (further) endless continued transport member 209 (i.e. the first continued transport member 209¹ in the embodiment of FIGS. 1 and 2 and the first further continued transport member 209³ in the embodiments of FIGS. 14 and 15), in each case forming part of or being connected to the first pick-up arm 201₁, is located close to the outer end on the discharge side of the (further) endless continued transport member 209 (i.e. the first continued transport member 209² in the embodiment of FIGS. 1 and 2 and the first further continued transport member 209⁴ in the embodiments of FIGS. 14 and 15) of the second pick-up arm 201², as the case may be at a position above the relevant outer end of the second pick-up arm so that picked-up fibre plants coming from the first pick-up arm 201¹ come to lie on top of the (further) (continued) transport member of the second pick-up arm 201². When the stream from the first pick-up arm 201¹ comes to lie on the stream from the second pick-up arm 201² at the position of the outer ends, the two streams are combined into one single combined stream of fibre plants/fibre plant parts. With the construction described here the swathes come to lie precisely on top of each other with no substantial difference in position, preferably at a central position.

This positioning of the pick-up arms 201¹ and 201² relative to each other (i.e. the outer end of the relevant transport member of the first pick-up arm immediately above the relevant transport member of the second pick-up arm) forms a preferred embodiment of a combining unit 233 whereby different streams of fibre plant can combined before the combined stream of fibre plants or parts thereof are sent alternately to a first and second rolling unit 4 by the distributing unit 301 to be described below. In this embodiment the combining unit 233 therefore comprises the outer ends of both (continued) transport members. The part of the lower continued transport member 209², 209⁴ on which the fibre plants of the upper continued transport member 209¹, 209³ come to lie is also referred to here as the collecting area 216.

In the embodiment shown in FIGS. 14A-14C collecting area 216 is therefore located at outer end 212 of one of the pick-up arms (more particularly of pick-up arm 201₂). In other embodiments the collecting area is conversely located at the position of the self-propelling vehicle 101, more particularly at the position of a transport unit 3 provided on self-propelling vehicle 101. According to the embodiment of FIGS. 14A-14C, the combining unit furthermore forms part of the pick-up arms of pick-up unit 2. In other embodiments a separate combining unit is however provided, for instance arranged on the chassis 102 of vehicle 101.

In the above described embodiments use is made of two separate pick-up arms 201¹, 201². Depending on the wishes of the user, it is however likewise possible to equip a device 1 with a single pick-up arm 201 or with more than two pick-up arms 201¹ and 201², for instance three, four or five pick-up arms 201. It is possible to arrange some of the pick-up arms on device 1 and some detachably, or to separately supply additional pick-up arms 201 which can be additionally mounted. It is also possible to embody a pick-up unit 2 in a manner other than as one or more arms.

Each pick-up arm 201¹, 201² comprises a driven or driveable endless transport member 202 (FIGS. 2B and 2C) which is configured to, during travel of self-propelling vehicle 101 over the ground, pick up retted fibre plants or parts thereof from this ground and to transport the picked-up retted fibre plants or parts thereof toward the self-propelling vehicle 101 as a stream. The endless transport member 202 comprises for instance an endless belt or endless chain which is arranged around rollers or wheel members 203A and 203B (FIG. 2A). The roller or wheel members 203A, 203B are bearing-mounted for rotation relative to the relevant frame 204¹, 204² of the pick-up arm 201¹, 201². Each of the pick-up arms 201 can be provided with its own drive for driving the one or more corresponding endless transport members (i.e. transport members 202, 209 and so on), for instance an electric drive or a hydraulic drive, optionally powered via the above stated hydraulic system of the vehicle. This drive can then drive the endless conveyor belt 202, for instance by driving at least one of the wheel members 203A, 203B around which the belt is arranged.

As shown in FIG. 2B, the endless transport member 202 can be configured to rotate in a direction such that the underside of the endless transport member 202 moves substantially in the direction of movement B of vehicle 101, for instance in the sense that the horizontal component of the transport speed of the underside of the endless transport member has a direction equal to the direction of travel of vehicle 101. The horizontal component of the transport speed of the underside of the endless transport member however has a magnitude which is slightly smaller than the advancing speed of the vehicle. In other words, the drive is configured to have the endless transport member co-displace with the displacement of the vehicle in the vehicle direction, but in a manner such that the co-displacement is prevented to some extent so that the fibre plants can be picked up. This construction has a number of drawbacks. One of the advantages is that the pick-up system moves along with the flow of the vehicle and the fibre plants are taken up (picked up) much more gently by the pick-up system due to the fact that the picking up takes place in the same direction as the direction of travel of the vehicle. This may result in reduced loss and/or less damage to the fibre plants during picking up.

The vertical (upward) component of the direction of movement of the transport member during picking up is furthermore relatively small, especially compared to constructions wherein use is made for picking up of a pick-up drum or the like. This ensures a uniform, non-abrupt and smooth pick-up movement and likewise a minimal risk to bystanders who could otherwise for instance be hit by rocks and the like flying around as a result of the turning of the pick-up drum. The picking up “in the flow” (as well as the relatively great width covered by the pick-up arms) ensures that picking up from the ground is less susceptible to error, especially when there are a lot of weeds, and reduces the amount of dust and soil remaining between the picked-up fibre plants. The position of the swathe for picking up can also be readily detected using a camera while picking up is taking place. This simplifies the ability to properly “follow” the swathe when the vehicle travels over the field.

In determined embodiments each of the pick-up arms is provided with a vibrating mechanism whereby at least one of the transport members can be set into vibration so that, when fibre plants are transported by the relevant transport members, dust and sand can be easily vibrated off the fibre plants. This sand and dust will then no longer find its way into the rest of the device, this reducing the need to clean the device and therefore having a positive effect on the utility of the device.

FIG. 2B indicates the preferred directions of displacement of the endless transport members 201, 202 with arrows. The picked-up fibre plants (v) or parts thereof (indicated with black dots in FIG. 2B) can then be transported in a stream underneath the endless transport member 202 toward vehicle 101. After the stream of fibre plants or parts thereof has been transported underneath the whole transport member 202 they can be processed further. Transporting the stream only underneath transport member 202 and/or underneath the whole pick-up arm 201 instead of along the upper side keeps the transport simple and relatively unsusceptible to error, among other things. Further advantages of this construction will be described below.

An endless transport member 202 can be provided from gripping elements 205, for instance bent or curved pick-up teeth, protruding from the outward-directed surface. These pick-up teeth can be made of relatively stiff material such as steel/hardox or hard plastic, or of somewhat resilient material, such as spring steel, flexible plastic and the like. When embodied as teeth, the gripping elements 205 can comprise a first, radially extending tooth part and a second, longitudinally extending tooth part, as seen from transport member 202. These gripping elements 205 can be distributed uniformly over the surface of the endless transport member 202, for example placed at a regular distance one behind the other and/or placed adjacently of each other in rows.

Gripping elements 205 are preferably favourably bent or curved for the purpose of picking up fibre plant parts in that, at the position of the side of the free pick-up end of pick-up arm 201 directed toward the ground, they are parallel to the ground, preferably at the lowest point under the endless transport member 202, and there protrude straight forward in the longitudinal direction of the endless transport member 202. Gripping elements 205 will hereby be pushed into the swathe (z₁, z₂) or come to lie against the underside of the swathe for picking up, slightly lift up the stream 10 of fibre plant parts, and carry them to a stream space 206 under the endless transport member 202. The stream space 206 is particularly bounded on the inner side by a belt 237 (FIG. 2B) and on the outer side by channels 238 which are open on the underside and are formed by pairs of upright parallel plates 239¹, 239² (such as for instance shown in FIG. 2A, wherein this figure shows four channels 238, although this number can of course be greater or smaller). The channels 238 are here embodied such that the plates 239¹, 239² define an elongate intermediate space along which the free outer ends of gripping elements 205 can pass. In a favourable embodiment the gripping elements can particularly be the first elements which, during picking up, come into contact with the fibre plants or parts thereof resting on the ground and/or pick up fibre plants or parts thereof resting on the ground from the ground without assistance from other elements of the device.

The endless transport members 202 can be configured such that the rotation speed (S₁) thereof can be controlled, and a plurality of endless transport members 202 can be used at the same rotation speed. It is favourable to keep this rotation speed of endless transport member 202 somewhat lower than the travel speed of vehicle 101 (the travel speed being shown schematically with S₂ in FIG. 2B), for instance 10%-50% lower, preferably between 20%-30% lower. This is because fibre plant parts will hereby be pulled in effectively by the endless transport member 202. The need to press down on the fibre plant parts, which may cause soil to cling to the fibre plant parts, is furthermore avoided. The transport speed of transport members 202 is preferably adjusted to a selected or detected momentary travel speed of the self-propelling vehicle 101 (which travel speed can be determined by a speedometer provided on the pick-up arm or the vehicle and configured to generate a travel speed signal representative of the momentary or average travel speed of the pick-up arm) in order to keep the transport speed a determined absolute value or factor lower than this travel speed.

It has been found by applicant that when a method is applied wherein such relative speeds are maintained during picking up, travel can take place at a higher travel speed than is usual in the prior art. Good results are for instance achieved when the travel speed (S₂) is roughly 25 km/h and the transport speed (S₁) of transport members 202 is about 18 km/h. In other words, it is possible to realize a high travel speed in combination with less contaminating material being picked up from the ground. Picking up contaminating material such as soil, rocks, dust and weeds together with the fibre plants creates problems downstream of the pick-up unit, for instance an increased cleaning and/or maintenance effort but also a danger to bystanders since the rocks, for example, may begin to fly around during picking up. Such contaminating material must furthermore not find its way into the fibre plant bales to be formed later. A further drawback is for instance that, when unrolling contaminated bales in the factory, harmful substances such as silicon may be released. In the long term this can be harmful to people working in the factory.

The endless transport member 202 can be provided on the downstream side (rear side) 208 with a detector unit 207, for instance a pivoting plate (see also FIG. 15D), via which the picked-up fibre plant (parts) (v) flow toward said further endless transport member 209. In other embodiments the detecting unit 207 can be configured to perform an ultrasonic or otherwise contactless thickness measurement.

Detecting unit 207 can be configured to detect the momentary thickness of stream 10 of picked-up fibre plants or parts thereof. A part of the signal generator 226 (shown schematically in FIG. 15D) forming part of detecting unit 207 can then generate a detection signal representative of the detection result and transmit it via a wired or wireless communication connection to the above stated central control unit 13. On the basis of calculations by control unit 13 the transport speed of at least one of the endless transport member 202 and the endless continued transport member 209 can then be determined and subsequently set. More particularly, a higher or lower transport speed of each of the transport members can be opted for on the basis of the detection signal in order to make the momentary thickness of the stream fed through the endless continued transport member 209 more uniform.

In the embodiment of FIG. 14D the detecting unit 207 comprises a flap 207 arranged pivotally on frame 204 (more particularly on frame 204¹). Arranged at the pivot point is a torque angle gauge (not shown) which periodically measures the angle of rotation (α) formed by flap 207 relative to frame 204. This angle of rotation is a measure of the thickness of the fibre plant bundle. The output signal of this torque angle gauge is thereby representative of the thickness of the bundle of fibre plants being transported by the pick-up arm at a determined moment.

As already stated above, one or more endless continued transport members 209 can be located further rearward on a pick-up arm 201, wherein the side of front 210 of the front endless continued transport member 209 directed away from the ground lies at a lower position than the side of the rear 208 of endless transport member 202 directed away from the ground. The endless continued transport members 209 are configured to displace fibre plant parts toward a distributing unit 301 of a transport unit 3 of device 1 (see inter alia FIGS. 2D, 3A-3C and 10A-10B for more detail). These continued transport members are provided with carriers 228 to facilitate transport of the fibre plants. It is noted that the fibre plants (v) are transported on the upper side of the continued transport members 209 rather than on the underside, as was the case with transport members 202 (see FIG. 2B).

As already described above, a pick-up arm 201, 201¹, 201² can comprise a pivoting unit. This pivoting unit can for instance comprise a first pivoting unit 214 which is arranged to make pick-up arm 201, in any case a rear part of pivoting unit 214, pivot relative to vehicle 101 in order to change the lateral position of pick-up arm 214 or the front part thereof (see arrows 231¹ and 232² in FIG. 2C). The lateral position is understood to mean the directional component in the transverse direction of vehicle 101 and/or in a direction at right angles to the direction of movement of vehicle 101, in the horizontal plane. As described above, in determined embodiments such a pivoting unit 214 can be combined with mounting means 11 for mounting pick-up arm 214 on chassis 102 of vehicle 101, for instance in that the pivoting unit 214 forms part of the mounting means, or vice versa.

The pivoting unit of a pick-up arm 201 can also comprise a second pivoting unit 214² which is arranged between two parts (also referred to here as segments) of pick-up arm 201¹ and/or 201², for instance between a segment containing the endless transport member 202 and a segment containing the endless continued transport member 209 of pick-up arm 201 of each of the pick-up arms 201¹ and/or 201², in order to make these two parts/segments pivot relative to each other (see the double arrow 230 in FIG. 2C). It is also possible to provide a plurality of second pivoting units 214² between different pairs of adjacent parts of a pick-up arm.

FIG. 2A for instance shows that for each of the two pick-up arms 201¹ and 201² a pivoting unit 214 is arranged between a chassis/frame 204¹, 204² with endless transport member 202¹, 202² (including drive) and a frame 204¹, 204² with endless transport member 209¹, 209² (including drive), so that the segments are as it were coupled to each other in series between the respective front end 211 and rear end 212.

As shown in FIG. 2A, a first or second pivoting unit 214, 214² can for instance comprise one or more actuators in the form of two hydraulic cylinders 223 arranged substantially adjacently of each other in lateral direction. Such an arrangement is also present in the further embodiment of the invention shown in FIGS. 14F, 14G. These figures show parts of an embodiment of a pick-up arm 201 in which the first pivoting unit 214 comprises two pairs of cylinders 223^{H}, 223^{V} and a second pivoting unit 214² comprises two cylinders 235. In determined embodiments the second pivoting unit comprises a spindle for manually controlling the angle, for instance with the object of adapting the quality of the pick-up system to the condition of the fibre plants to be picked up.

A pivoting unit comprising two of such cylinders 223^{H}, 223^{V}, 235 can be configured to have each cylinder of a cylinder pair be operated independently of the other cylinder of the pair in order to change the distance between the parts of pick-up arm 201 on a first lateral side connected by pivoting unit 214, 214² relative to the distance between these parts of pick-up arm 201 on the other lateral side.

As described above, pick-up unit 2 can be configured such that different parts thereof can be adjusted, i.e. be pivoted, in respect of lateral position. Device 1 can for instance be configured to have a user bring about this change in position when the device is not in use (at least when the device is not travelling over the field and processing fibre plants, for instance immediately before entering a field) and/or when the device is actually in use (and so is picking up the fibre plants and processing them further).

A pick-up arm 201 can be configured such that the height of the free pick-up end of pick-up arm 201 can be adjusted to the height of the ground. For this purpose each pick-up arm 201 can be provided with height adjusting means 213, for example a height-adjustable support wheel or leading wheel 213 (see FIG. 15E) which is mounted on the front part of the device. The free pick-up ends of all the pick-up arms 201, and thereby endless conveyor members 202, are preferably positioned at the same height. Alternatively, such a wheel can be mounted under the free front end 211.

FIG. 15E shows a specific embodiment of a leading wheel. The shown leading wheel 213 comprises an upright spacer which is attached with an upper part 218 to a rod 217 of chassis 204 (more particularly chassis 204¹ of first arm 201¹ and chassis 204² of second arm 202²). A wheel element 221 (also referred to here as support wheel) which rests on the ground is attached to a lower part 220 of the spacer. Situated between the upper part 218 and the lower part 220 is a middle part 219 which is length-adjustable. It is possible to provide means for manual adjustment, and/or means for automatic adjustment of the length such as an electronic control element and/or a hydraulic control element, for instance a hydraulic cylinder.

If means for automatic adjustment are provided, these can be embodied to adjust the length of middle part 219 during travel from driver's cab 105 and/or fully automatically, so without the intervention of a person. This latter can for instance be done on the basis of observation signals from an observation unit 215 which is present in some embodiments as part of device 1 and which will be further elucidated below with reference to FIG. 9E. The leading wheel can be provided with a guide element 222 which comprises for instance one or more horizontal teeth or plates protruding rearward from the lower part of the vertical spacer. Such a guide element 222 serves to guide fibre plants or parts thereof rising up from the ground toward the gripping elements 205 at the free front end 211 of pick-up arm 201. This can eliminate the phenomenon of fibre plants or parts thereof sticking to wheel element 221 or being thrown up by wheel element 221 when wheel element 221 passes thereover, and in this way escaping the grip of gripping elements 205 or even accumulating in the vicinity of leading wheel 213 and thereby disrupting the action of leading wheel 213.

A pick-up arm 201 can be configured such that the position of rear side 212 of pick-up arm 201 relative to distributing unit 301 can be changed in the height direction and/or transverse direction. A part of pick-up arm 201 or the whole pick-up arm 201 can thus be pivoted in upward and downward direction, depending on the variation of the height of the ground, for instance by means of a height detection system in combination with lifting means for lifting (the relevant part of) the pick-up arm 201. For this purpose pick-up arm 201 can for instance be provided with a hydraulic cylinder, manual spindle or electric actuator.

The outer ends of a plurality of pick-up arms 201 can be arranged on the side of distributing unit 301 such that during operation they can be arranged one above the other at the same transverse position in order to supply their respective fibre plant parts to distributing unit 301 at essentially the same transverse position.

In the above described embodiments the pick-up units are embodied to pick up the fibre plants with gripping elements 205 protruding from an endless transport member 202. In other embodiments use can however be made of one or more pick-up drums (an embodiment of which is shown in FIG. 17) or of one or more sun gears (an embodiment of which is shown in FIG. 18).

Referring to FIG. 17, an embodiment is described below in which a per se known pick-up drum is used as pick-up element. This drum is positioned at the free outer end of each of the pick-up arms and can rotate. During rotation the pick-up drum picks up fibre plants and guides them to an endless transport member which transports the picked-up fibre plants to an endless continued transport member 209. Examples of such a pick-up drum are known from the patent document BE 1 028 410 A1 of the same applicant, the content of which should be deemed incorporated herein. The pick-up drum 600 has a generally cylindrical form and is embodied to be rotatable about an (imaginary) rotation axis 601, for instance a horizontal axis extending in principle transversely of the longitudinal direction of the vehicle. The rotation direction (R) is opposite to that of the wheels of the vehicle. The rotation speed may vary, but is often greater (for instance 10-30% greater) (although in other cases also smaller, for instance up to 50% smaller) than the rotation speed of the wheels of the vehicle. Arranged all around the radial peripheral surface 603 of pick-up drum 600 are a plurality of rows (in the shown embodiment three rows, although this number can be greater or smaller) of pick-up pins 604 which move reciprocally in radial direction during rotation of the pick-up drum and protrude outside the radial peripheral surface 603. Pick-up drum 600 can be driven in a number of different ways. In determined embodiments each of the pick-up drums is driven directly by a separate drive unit, although in other embodiments this will take place in indirect manner, for instance by one or more drive belts trained round one or more of the pick-up drums and one or more pulleys driven by drive motors, for instance hydraulic drive motors.

The pick-up pins 604 of each of the rows extend in radial direction from a common point (more particularly a common eccentric shaft, not shown), wherein this common point is non-concentric (i.e. positioned eccentrically) relative to a centre point of the pick-up drum formed by the (imaginary) rotation axis 601. This has the result that the pick-up pins 604 protrude relative to the radial peripheral surface 603 when they are located at rotation positions on the underside and front side of the pick-up drum and have been pulled wholly or partially inward at other rotation positions of the pick-up drum. Pick-up pins 604 are thereby eminently suitable for picking up the stalks of the fibre plants lying (horizontally) on the ground and lifting them off the ground, wherein fibre plants continue to be held in the lying position.

Referring to FIG. 18, an embodiment is described below in which the pick-up element is a sun gear 650. Sun gear 650 is provided at the free outer end of each of the pick-up arms 201 and in the shown embodiment comprises a substantially cylindrical drum 652 mounted rotatably on the frame of pick-up arm 201 via rotation shaft(s) 651. Cylindrical drum 652 does not have its own drive motor. Driving for instance takes place with the friction relative to the ground when the vehicle advances and/or by means of a separate drive motor. In a determined embodiment the sun gear is driven at a lower speed than the travel speed of the vehicle, for instance a speed which is slower by a similar percentage as the speed of the pick-up conveyor is slower than the travel speed, for instance 300% slower or less (for instance only 10-50% slower).

Rows of gripping elements 655 are arranged on the peripheral surface 653 of the cylindrical drum. These gripping elements 655 can have the same form and dimensions as the above stated gripping elements, although variations in the form and/or dimensions are also possible. What is important is only that when cylindrical drum 652 rotates, the fibre plants resting on the ground are picked up by the gripping elements 655 and the picked-up fibre plants are carried to one or more discharge conveyors 209 which then transport the fibre plants toward the vehicle.

### Pick-Up Unit—Following Swathe by Pivoting Conveyor

FIGS. 9A-9E show schematically different possible advantageous ways of pivoting the pick-up arms or parts thereof (such as the endless transport members) relative to the self-propelling vehicle 101. Of these, FIGS. 9A-9D show examples of the pivoting of the pick-up arms for setting a suitable pick-up angle of each of the pick-up arms and setting the angle of travel of vehicle 101. FIG. 9E shows an example of the pivoting of a conveyor relative to the rest of a pick-up arm to enable rapid variations in the positioning of the swathe to be followed during travel. For the sake of clarity the figures are shown schematically and determined components, such as storage and/or processing units, have been omitted.

FIG. 9A shows a method wherein two pick-up arms 201¹, 201² mounted pivotally on a self-propelling vehicle 101 pick up the fibre plants of two mutually adjacent swathes z₁ and z₂ in symmetrical manner and transport them to vehicle 101. The two arrows further indicate that the two streams of picked-up fibre plants also come to lie at vehicle 101 in two mutually adjacently positioned streams. In other embodiments the two streams come to lie straight or obliquely one above the other at the position of vehicle 101. No swathe has further been drawn on the rear side of vehicle 101 since the fibre plants are in this specific embodiment processed into bales and the fibre plants are therefore no longer placed on the field behind vehicle 101.

FIG. 9B shows a method wherein two pick-up arms 201¹ and 201² pick up the fibre plants from two parallel, non-adjacent swathes z₁, z₃. A single third swathe z₂ is here located between the two swathes z₁, z₃. The third swathe z₂ is not picked up and therefore continues behind vehicle 101. The two picked-up swathes z₁, z₃ can for instance comprise a first type of fibre plant part, such as the upper parts of the hemp, kenaf, jute, sisal or flax plants, while the third swathe z₂ comprises a second type of fibre plant part, such as the lower parts of the same hemp, kenaf, jute, sisal or flax plants, or vice versa. Once the picked-up and transported fibre plants have come to lie on vehicle 101 and are rolled up, it can thus be ensured that each bale consists only of a single of said two types of fibre plant part so that a specific composition of fibre plant parts can be achieved for each bale. The intermediate third swathe z₂ can simultaneously be driven over with the respective left and right wheels 103 on either side, so that it is not disrupted unnecessarily.

FIG. 9C shows a method wherein two pick-up arms 201¹, 201² are positioned at different angles in order to treat two swathes z₁ and z₂ which, although lying adjacently of each other, do not extend symmetrically relative to an axial central imaginary axis (of symmetry) 250 of vehicle 101.

FIG. 9D shows a method wherein vehicle 101 moves in a crabbing motion and picks up a single swathe z₅ with a single pick-up arm 201, without vehicle 101 driving over adjacent swathe z₄ which may not lie clear yet. A single swathe z₅ can hereby still be picked up with a single, relatively short pick-up arm 201 arranged centrally on vehicle 101 without disrupting adjacent swathes. The crabbing motion is possible in the shown embodiment in that it is not only the position of the front wheels relative to the longitudinal axis of vehicle 101 that is adjustable, but the position of the rear wheels as well.

In determined embodiments it is possible to set the angle at which a pick-up arm 201¹, 201² is positioned relative to the front of vehicle 101 and the angle at which the front of the pick-up arm is positioned relative to the direction of movement and/or swathe 8 to be picked up. This angle can for instance be adjusted while vehicle 101 is stationary and/or be controlled during travel of vehicle 101, while device 1 is in operation and/or not in operation. Swathes 8 can thus be alternately picked up in front of and/or adjacently of vehicle 101 in different ways with the same device 1.

As described above, for the purpose of controlling the position of a pick-up arm 201 this arm can for instance be provided with two pivoting units 214, 214² instead of one single pivoting unit. Pivoting unit 214 forms a first point of rotation on the back of pick-up arm 201 and pivoting unit 214² forms a point of rotation closer to the front of the pick-up arm. Embodying a pick-up arm 201 with one or more of such points of rotation inter alia enables the device to be preset, i.e. before the picking up begins, such that the front of pick-up arm 201 is always able to remain at right angles to the swathe at different transverse positions.

FIG. 9E shows schematically a top view of a further embodiment of the invention. The figure shows a vehicle 101 provided with four wheels 103. The point of rotation of the above described first pivoting unit 214 is shown on the front side of vehicle 101. A single pick-up arm 201 (although this can also be a plurality of pick-up arms) is mounted on this pivoting unit 214. In the shown embodiment (compare the embodiment of FIG. 15H) the endless transport member 209 of pick-up arm 201 is reciprocally pivotable, in lateral directions, via a pivoting element 401. The pivoting movement is realized by the above stated actuator 405. The endless transport member 209 can be moved reciprocally very rapidly and the device can thus follow (for example by keeping to the centre of the swathe as far as possible) variations in the lateral position of the swathe (z) accurately (within narrow limits, for instance within 5 cm or even within 2 cm) while travelling (at the usual vehicle speed). The following of the varying position of the swathe (z) is controlled by the control unit 224 to be described below, which generates a control signal and sends it to actuator 305. The control signal is generated by the control unit 224 on the basis of a manual input by the driver and/or (preferably) on the basis of signals coming from an observation unit 215 to be described below.

In some embodiments device 1 comprises at least one observation unit 215, for instance as part of pick-up unit 2 or as part of vehicle 101. Referring to FIG. 9E, an embodiment is shown of a device 1 in which a single observation unit 215 is provided for the purpose of observing the supply coming from a single swathe 8 of picked and/or cut fibre plants arranged parallel on the ground to greater or lesser extent. In other embodiments a single observation unit 215 is provided for two or more pick-up arms, or a single observation unit 215 per pick-up arm. In these other embodiments the one or more observation units 215 are configured to observe the respective swathe 8. In all cases the one or more observation units provide an observation signal generated on the basis of the observation. The observation signal is representative of the positioning of the swathe (for instance in direct manner when the observation area is located immediately in front of the pick-up element or in indirect manner when the observation area is located at the position of the pick-up element, such as for instance the endless transport member, the pick-up drum or the sun gear) and makes it possible to have endless transport member 209 follow the swathe automatically (so in principle without any input by the driver). In determined embodiments it is even possible to have the device travel along so-called imaginary geographic (GPS) lines automatically during the picking of the fibre plant and/or during the turning. These imaginary geographic lines preferably (and under ideal circumstances) correspond with the paths of the swathes along the ground. Information about these lines can be saved beforehand on a storage medium of a control unit and/or can stored remotely (external server, cloud storage and the like). The origin of these lines can vary. In some situations the lines come from a harvesting machine that has driven over the field previously. In other situations the lines may be determined in other manner. While travelling, the vehicle of the device follows these imaginary lines (automatically or steered by an operating person) on the basis of the momentary position information for instance received from the position determining system, and the laterally reciprocally displaceable transport member 209 of the device follows the fibre plants independently thereof (i.e. independently of the device itself, more particularly the pick-up arm of the device, following the imaginary lines) on the basis of said observation signal (with image information). In other words, in determined embodiments the device can travel along the field autonomously, while the lateral position of the fibre plant conveyor simultaneously adapts to the provided image information (for instance adjustment relative to the centre of the observed images of the fibre plants).

The observation unit 215 is preferably positioned adjacently of or under the pick-up belt (endless transport member 202, see for instance FIG. 15H) at the position of the pick-up drum 600 (if present, see for instance FIGS. 17, 18) or the like. Observation unit 215 is configured to generate an observation signal representative of the positioning (i.e. the lateral position) of the fibre plant parts immediately before they are picked up, while they are being picked up and/or immediately thereafter, for instance immediately behind the pick-up element such as a pick-up drum 600 or the like. More generally, the observation unit 215 is configured to observe the fibre plants in an observation area 227 (represented schematically in FIG. 9E as a rectangular area, although another shape is also possible) and to generate the observation signal representative of the observation (for instance image data in the form of periodically taking snapshots or comprising a video). The pick-up area 227 extends in lateral direction, preferably over at least the whole width of a swathe, so that the varying lateral positions of the fibre plants (v) can be detected during travel. In axial direction the observation area 227 preferably extends over the area of pick-up unit 2 (for instance the endless conveyor 202 of FIG. 15A, the pick-up drum 600 of FIG. 17 or the sun gear 650 of FIG. 18) and/or the area of the outer end of endless transport member 209¹ freely pivotable in lateral direction. In determined embodiments the observation area is located on the underside of the pick-up arm, immediately before picked-up fibre plants are engaged and carried along by the endless transport member 209¹ during travel.

As stated, the observation signal contains observation data which are for instance representative of the lateral positions of the fibre plants which vary at least during travel. Other features, such as the width of the swathe, the centre of the swathe, the average length of the fibre plants lying on the ground and the like can also be determined from the image data.

In determined embodiments the observation unit 215 comprises one or more cameras, for instance visible light cameras or infrared cameras. The swathe that can for instance be followed on the basis of the observed colour and/or texture of the ground/fibre plants. When cameras are used, the observation data comprise image data. As alternative or in addition to a camera, an observation unit 215 can comprise one or more other types of sensor, for instance a laser system or an ultrasonic detection system, wherein the observation data will therefore contain different kinds of information. If necessary, an observation unit 215 can be embodied to preprocess the incoming information in order to ensure that the observation signal contains more relevant or more compact information for the control unit 224 described below (for instance the above described central control unit 13 or a separate control unit).

The device can further be provided with a position determining system 225 (also referred to here as a position determining unit), for example a GNSS receiver configured to determine a global position of a swathe observed by an observation unit and/or of the vehicle. The position determining system 225 can for instance be configured to determine the momentary global position of the vehicle, for instance with the object of having the vehicle, and more particularly the pick-up unit thereof, follow the above stated imaginary GPS lines (which GPS lines are known beforehand and are optionally stored beforehand in a storage medium, for instance the storage medium of the control unit) on the field. Because the vehicle with the pick-up unit mounted thereon is able to follow the imaginary lines, the swathe is followed during travel. Any large variations (also referred to here as macrovariations) per length unit (i.e. over a unit of distance travelled) in the lateral positions of a swathe are followed, as long as these macrovariations fall within the position determining accuracy of the position determining system 225 and/or within the accuracy of the prestored lines. Small variations in the lateral position of the swathe (in particular for example the average position of the swathe, for example the position of the centre line through the swathe) can be accommodated by the above stated pivotable endless transport member 209. When they fall within the compensation range of the pivotable endless transport member 209, for instance a compensation range of +/−30 cm relative to the above stated imaginary geographic (GPS) line, these smaller variations can be followed without the direction of the vehicle and even of the pick-up unit itself having to be adjusted here. This compensation range can be determined by the maximum physically possible compensation by the reciprocal movement around the pivot point of the pivotable endless transport member 209 and/or by a range set in the software of the control unit of the actuator of the pivotable endless transport member 209.

Microvariations in the lateral position of a swathe (for instance lateral divergences in the position of a swathe of less than 30 cm (per metre travelled) of swathe length) cannot be followed or cannot be followed properly (particularly not accurately and/or not quickly enough compared to the travel speed of the vehicle and the manoeuvrability of the vehicle) on the basis of the position determining system 225 alone. These microvariations can however be detected during travel by observation unit 215 and, on the basis of this detection, the control unit can decide (for instance in the case of a detected variation of more than a predetermined value, for instance 2 or 3 cm, between the detected centre line of the swathe and the imaginary geographic line) that the actuator must be controlled so that the pivotable endless transport member 209 will begin to compensate for these microvariations. If the variation becomes too great, for instance more than the compensation range of the pivotable endless transport member 209, either only the pick-up unit itself and/or (preferably) the vehicle itself can be adjusted in order to bring the variations in the swathe within the compensation range of the pivotable endless transport member 209 again.

It is otherwise also possible with the displaceable transport member 209 to follow variations in the positioning of the swathe other than the above stated microvariations. In determined situations there may be a discrepancy between the position determined by the position determining system and the actual position. It can thus be the case, for instance when the ground slopes (on a hill or incline), that the imaginary geographic lines (for instance the GPS lines) do not correspond wholly with the actually desired pick-up paths of the pick-up arm and have for instance a more or less fixed variation (in the order of magnitude of ten centimetres or even more). Using the observation data, this variation can be detected and the displaceable transport member 209 can be displaced to a shifted lateral position.

As already described above, the thus determined varying lateral positions can be factored in by the above stated control unit 224 when generating the control signal. This control unit can be embodied in different ways, for instance as electronic control element on the respective pick-up arm 201 or optionally combined with control units 224 of other pick-up arms 201, as electronic element on vehicle 101, or as software running on a device on vehicle 101, for instance as part of the steering and control units 104 in driver's cab 105.

Combined control units 224 can comprise an element or computer program for controlling an arbitrary number of pivoting units 214. In such combined control units 224 the different pivoting units 214 of different pick-up arms 201 as well as the actuator 405 of the pivoting movement of the sub-frame of the endless transport member 209 can be controlled independently of each other. When more than two pick-up arms 201 are used, such an embodiment is particularly favourable since the chances of any significant mutual variations occurring in the positions of a number of followed swathes increase when more than two swathes are being followed.

One or more control units 224 taking the form of software can also be run at least partially on an external device (not shown) which is connected to the respective pivoting unit via a communication unit (not shown) of vehicle 101.

Control unit 224 can receive said observation signal via a fixed or wireless electronic communication connection and convert the data in the observation signal into a control signal which is once again transmitted to the actuator 40 via a fixed or wireless electronic connection.

The control unit can be embodied with one or more artificial intelligence systems, for instance neural networks, which are configured and trained to convert input data of a determined type into output data of a different type. It is thus for instance possible to configure and train an artificial intelligence system such that it accepts an input comprising optionally preprocessed data from the received observation signal and generates a lateral distance as output, this in order to perform the above stated intermediate step. It is also possible to configure and train an artificial intelligence system such that it accepts an input comprising the lateral distance and generates a control signal for pivoting unit 214 as output, this in order to perform the above stated second step.

An artificial intelligence system can for instance also be configured and trained to accept an input which comprises optionally preprocessed data from an observation signal and generates a control signal as output, this without intermediate step. In the latter case it is not necessary for the control unit to model the physical situation around the swathe observed by observation unit 215 in any way.

### Collecting and Distributing Fibre Plants

Whatever the manner in which the streams of fibre plants are joined into a single, combined stream, they eventually come to lie at transport unit 3 of vehicle 101. Details of a first embodiment of this transport unit 3 are shown in FIGS. 3A-3C.

The transport unit 3 comprises the above stated distributing unit 301 and a number of endless conveyors 302A, 302B, 302C, and is preferably situated at a relatively low position in vehicle 101, close to the upper side of vehicle chassis 102. Distributing unit 301 serves to carry the fibre plant parts supplied by pick-up arms 201 to the storage or collecting area 216 toward a specific rolling unit 4 to be selected (i.e. a first rolling unit and a second rolling unit). Distributing unit 301 can be embodied such that, any time that the distributing unit 301 is operative, the supplied fibre plant parts (which were combined into a single stream 10C in the above stated combining unit 233) are sent to one of the rolling units 4 in question.

In a preferred embodiment of the device in which two (or more) parallel streams 10A, 10B are supplied from the picking unit the distributing unit 301 in each case sends the streams 10A, 10B of fibre plant parts being supplied simultaneously from different pick-up arms 201¹, 201² on to the selected rolling unit of the two rolling units 4 as desired.

When two rolling units 4 are used, distributing unit 301 can for instance be embodied as a star roller (shown schematically in FIGS. 3A-C) which is able to rotate in two directions (i.e. a first rotation direction and a second rotational direction). By opting for a rotation direction such that carriers 403 (in this embodiment the star points of the star roller) rotate upward at the front the distributing unit 301 sends the stream 10C of fibre plant parts on toward the first, front rolling unit 4, and by opting for an opposite rotation direction, so that carriers 403 rotate downward at the front, the star roller sends the stream 10C of fibre plant parts on toward the second, rear rolling unit 4.

FIGS. 10A-10B show a distributing unit according to another (second) embodiment. Distributing unit 301 is embodied here as a curved plate 404 with a row of parallel slots. This row runs in the lateral direction of vehicle 101 and carriers 403 protrude through this row, these carriers comprising in this embodiment a row of thin metal rods or fingers. In other embodiments the carriers 403 comprise a row of resilient teeth. Carriers 403 are mounted on a transmission 699 with crank and drive rod, and can be moved in two directions in order to perform a first rotating movement or a second rotating movement, as desired.

In the first rotating movement the carriers 403 are extended outward through the slots in curved plate 404 close to or under the rear side of collecting area 216 so as to carry along the supplied fibre plants or parts thereof. The carriers are then moved upward while protruding through the slots so as to transport the carried-along fibre plants or parts thereof upward along the surface of the plate, toward a roller 417 (see FIG. 2B/10B) of a rolling unit. Finally, the carriers 403 are pulled back behind the plate and moved back to the starting position.

In the second rotating movement the carriers are extended outward through the slots in curved plate 404 close to or above the rear side of collecting area 216 so as to carry along the supplied fibre plants or parts thereof. The carriers 403 are then moved downward while protruding through the slots so as to transport the carried-along fibre plants or parts thereof downward, for instance to the endless conveyors 702 described below. Finally, the carriers 403 are pulled back behind the plate and moved back to the starting position.

Displacing the fibre plant parts to said second rolling unit 4 is further done via endless conveyors 302 of transport unit 3. In the shown embodiment these are firstly parallel conveyors 302A and 302B and subsequently conveyor 302C, although other numbers of conveyors are also possible.

In the shown embodiment the transport unit comprises three endless conveyors 302. Initially, the fibre plants or parts thereof supplied from the first of the second pick-up arms 201¹, 201² are transported together over a first endless conveyor 302A and second endless conveyor 302B, these running parallel adjacently of each other. In this way the fibre plant parts are guided underneath the first rolling unit 4. The first and second endless conveyors 302A, 302B both debouch onto a third endless conveyor 302C, which transports both of the fibre plants or parts thereof upward to the second rolling unit. Alternatively, a single front conveyor can be provided instead of the first and second endless conveyors 302A, 302B.

It is possible to provide a further distributing unit (not visible in the figures) at the end of the rear endless conveyor (the third conveyor 302C in FIG. 2). This further distributing unit can be used to displace the transported fibre plants or parts thereof upward toward a rear rolling unit. The further distributing unit can also or otherwise be used to displace the transported fibre plants or parts thereof toward a rear rolling unit as desired.

### Baling—Rolling Up

FIGS. 4A-4I and FIGS. 5A-5D show a rolling unit 4 according to determined embodiments of the invention. To improve understanding, a part of the housing has been omitted in FIGS. 4A-4I so as to increase the visibility of the remaining parts. For the sake of simplicity of the drawing, the rolling unit is further shown in FIGS. 4A-4E without rolling conveyors (also referred to here as rolling belts or simply belts), while FIGS. 4H, 4I and 5A-5E show a similar rolling unit with rolling conveyors. All rolling units of the device have the same construction in principle. It is however noted here that the rolling unit 4 located closest to the pick-up arms receives the fibre plant parts directly via endless transport members of the pick-up arms (in determined embodiments directly via the endless transport member of second arm 201², since the fibre plant parts of the first arm are added to the fibre plants of the first pick-up arm in the collecting area), while the rolling unit 4 situated further rearward on the vehicle receives the fibre plants via conveyor 302.

It is further noted that in the embodiments of FIGS. 4A-4I and 5A-5D the method of supplying the fibre plants takes place via a supply belt 407 (for example a supply belt of conveyor 302) and therefore in fact shows the situation of the rear rolling unit, while in the embodiments of FIGS. 2A-2D and 10A-10B the supply takes place directly via the endless transport member 209 and the latter stated figures therefore in fact represent the front rolling unit. This difference is essentially irrelevant to the description of the further operation and construction of the rolling unit.

FIGS. 11A-11D show a discharge unit according to an embodiment for the purpose of discharging a bale of fibre plants rolled up in a rolling unit 4, while FIGS. 12A-12C and 13A-13B show a discharge unit in combination with an ejecting unit, wherein the latter unit is configured to eject or catapult a rolled-up bale from rolling unit 4.

A rolling unit, also referred to as rolling cell or baler, can be used to form bales of fibre plant parts. A rolling unit 4 is embodied to form bales of a determined width and a determined form, for instance cylindrical or beam-shaped.

The shown rolling unit 4 is configured to form drum-like, particularly (almost) cylindrical bales. Rolling unit 4 comprises a stationary support frame 422 (also referred to here simply as the frame, and wherein stationary is understood to mean that this frame is stationary relative to the chassis 102 of the vehicle 101 on which the frame is mounted) with a housing (partially cut-away in the drawings) and a receiving space 431 for receiving therein a stream of fibre plants or parts thereof and rolling them into a bale. The receiving space 431 is bounded by a number of bounding elements for bounding a receiving space with variable dimensions.

The bounding elements comprise two parallel lateral bounding elements 414 arranged at a variable mutual lateral distance to each other for the purpose of bounding receiving space 431 in the lateral direction. In the shown embodiment these lateral bounding elements form two width sides lying opposite each other and lying substantially at right angles to a radial supply side and radial unloading side. The lateral bounding elements 414 are arranged on the stationary support frame 422 via adjusting elements 416 to be described below, for instance in the form of actuators such as hydraulic cylinders, this in a manner such that the lateral positions can be adjusted individually (see double arrows 418 at each of the bounding elements in FIG. 4E). Each of the lateral bounding elements 414 can here be mounted and bearing-mounted directly on the relevant adjusting element 416, for instance on the relevant cylinder. In determined embodiments adjusting elements 416 can be configured to have the option of allowing the lateral bounding elements 414 to rotate (relative to an imaginary rotation axis extending in lateral direction) relative to the stationary frame 422, while in other embodiments this rotatability is not realized and the bounding elements are stationary relative to the stationary support frame 422, at least in the rotation direction. When the lateral bounding elements are rotatable, they can optionally co-rotate to greater or lesser extent with the rotating fibre plants (or parts thereof) in receiving space 431, as will be elucidated in more detail below.

Setting of the individual lateral position of one or more of the lateral bounding elements with one or more of the adjusting means 416 can be controlled (for instance via the control unit 13 connected to adjusting elements 416) such that the relative distance (i.e. the intermediate distance between the lateral bounding elements) can be adjusted (set) and/or that the lateral position(s) can be varied with a constant mutual distance. This latter option can be utilized for laterally reciprocally displacing receiving space 431 during travel of the vehicle over the ground, for instance subject to the path travelled by the vehicle. This can for instance contribute to a more uniform rolling up of the fibre plant parts, especially when the fibre plant parts are relatively short (for instance in the case of hemp).

The bounding elements further comprise one or more radial bounding elements extending substantially in an imaginary peripheral plane. In the shown embodiment these radial bounding elements comprise a number of elongate, flexible drive elements 423 arranged round a plurality of rollers 413, 713, 433, 436 for bounding of the receiving space 431 in radial direction. The radial bounding elements are also configured to enable a variation of receiving space 431, in this case a variation in radial direction (i.e. a variation in the radius of the bale to be realized with the rolling unit). This will be elucidated below. It will firstly be described how the elongate drive elements 423 realize the rolling movement of the supplied fibre plant parts.

In determined embodiments the elongate drive elements can be formed by rolling conveyors or rolling belts (also referred to simply as conveyors or belts) made of flexible/pliable material or by chains with slats, wherein the elongate drive elements (these forming the radial bounding elements) preferably extend parallel relative to each other. The elongate drive elements 423 are trained around a large number of laterally extending (transport) rollers 413, 713, 433, 436 for the purpose of together forming one or more endless conveyor belts. A number of the conveyor rollers is driven, wherein some of the conveyor rollers are arranged on the fixed, stationary frame 422 and other conveyor rollers are arranged on elements movable relative to the stationary frame 422, such as on the unloading door 408 to be described in more detail below, on the pivotable tensioning element 428 to be described below (also referred to here as the tightener, wherein each tensioning element 428 is drawn in FIG. 1B both in a first pivoting position (see reference numeral 428A) and in a second pivoting position (see reference numeral 428B)) and on the pivotable guide element 434 to be described below. Some of these conveyor rollers are positioned outside the collecting space and generally have a width greater than the mutual distance between the lateral bounding elements 414, other conveyor rollers can be located in the receiving space, at least inside the space defined by the lateral bounding elements 414, and are therefore less wide than the (minimum) intermediate distance between the bounding elements 414.

More particularly, conveyor rollers 413 (still more particularly conveyor rollers 413¹-413⁹) are mounted rotatably on the stationary frame 422, while conveyor rollers 713 (more particularly conveyor rollers 713¹-713³) are mounted rotatably on the movable unloading door 408, conveyor rollers 433 are mounted rotatably on the pivotable tensioning element 428, and conveyor rollers 436 (more particularly conveyor rollers 436¹-436³) are mounted rotatably on the pivotable guide element 434.

Tensioning element 428 has a frame 429 which is mounted pivotally via hinge 430 on stationary frame 422. Tensioning element 428 is held via one or more spring elements 435 attached to frame 429 and stationary frame 422. Tensioning element 428 has for its object to keep the elongate drive elements at a sufficient tension at all times.

The pivotable guide element 434 is arranged pivotally on stationary frame 422 via hinge 437 (pivoting direction indicated with a double arrow 443 in FIG. 5A) and is driven by an actuator 510, which comprises in determined embodiments an extending cylinder which is arranged on the vehicle on one side and on a support of the pivotable guide element 434 on the other and which is configured to thereby set the pivoting position of the pivotable guide element subject to the momentary dimensions of the bale (b) being rolled at that moment. The pivotable guide element 434 has for its object, among others, to roll up an increasingly larger bale of fibre material in controlled manner.

Rolling unit 4 can comprise an unloading door 408 which is arranged pivotally on stationary frame 422 and which takes the form of a frame part mounted via hinges or rotation shafts 410 on the stationary support frame 422, and is provided with a number of non-driven rollers 713¹-713³ (three in the figures, although this number can differ in other embodiments). This unloading door 408 is pivotable (see arrow 427 in FIGS. 4 and 5) between a wholly opened position shown for instance in FIGS. 4H and 5D and a wholly closed position shown for instance in FIGS. 4I, 5A and 5B (wherein FIGS. 4A-4F and 5C show unloading door 408 in a manner of temporary intermediate position between the wholly opened position and the wholly closed position for the sake of clarity of the figure). Unloading door 408 is in the closed position when the fibre plant parts are being supplied and rolled into a bale. It is only when the bale has been completely rolled and is ready to be removed from rolling unit 4 (and after sufficient tying material has been arranged around the bale) that unloading door 408 swings open. During pivoting, unloading door 408 continues to move underneath the part of the elongate drive elements 413 that is guided over the conveyor rollers mounted on the support frame.

The pivoting of unloading door 408 is driven by actuator 420. Actuator 420 is rotatably attached with a first outer end to the stationary support frame 422 and rotatably attached with the opposite outer end to a side of unloading door 408. An example of such an actuator is the hydraulic or electric extending cylinder which is shown in the figures and is configured to pivot unloading door 408 downward to the closed position and pivot the unloading door upward to the opened position by sliding respectively in and out.

The drive 412 for driving one or more of the (transport) rollers for setting the elongate drive elements 423 into motion can be formed by an electric and/or hydraulic drive motor 424 attached to frame 422 (FIG. 4A, for example a hydraulic motor powered from the hydraulic system of the vehicle) in combination with a number of toothed belts 440 four driving one or more of the (transport) rollers. Toothed belts are preferred over chains or other forms of transmission because toothed belts need essentially no maintenance (i.e. need not be lubricated, need not be kept clean, need not be hermetically sealed, but do have a long lifespan and/or produce little noise).

Drive motor 424 drives a conveyor roller 413⁷ via pulley 438 and a first toothed belt 440¹ and a conveyor roller 413¹ via the same pulley 438 and a second toothed belt 440². Further conveyor rollers 413³ and 413⁴ are driven via further toothed belts 440³ and 440⁴. The latter two conveyor rollers are not used to guide the elongate drive elements, but can come to be in direct contact with the fibre plants during the rolling. Further conveyor rollers 413², 413⁵, 413⁶, 413⁸ and 413⁹ are mounted on stationary frame 422 at diverse positions. The drawings show that two conveyor rollers 4136 are in fact provided, wherein only one is used (for instance depending on the desired diameter of receiving space 431).

The fibre plants are supplied in use via feed opening 399. As elucidated above, the supply of the stream of fibre plants (or parts thereof) can take place by displacement of an endless supply belt 407/302 which forms part of the transport unit 3 or by displacement of the endless transport member 209². Unloading door 408 is in closed position during the supplying (FIG. 5A). The direction of the supply of fibre plants is indicated in the figures with arrow 406. In the embodiment of FIG. 1 the feed opening 399 of each of the rolling units is situated on the front of vehicle 101. The direction of discharge (on the discharge side, also referred to here as the unloading side) of the fibre plant parts rolled into a bale is indicated in the figures with arrow 419.

Fibre plant parts received in the inner space formed by the endless conveyor belt (receiving space 431) are set into rotation by having the elongate drive elements 423 trained round the conveyor rollers rotate in a suitable direction. The elongate drive elements 423 are in turn set into motion by said driven conveyor rollers.

The elongate drive elements 423, conveyor rollers 413, 713, 433, 436 determine the maximum size of the receiving space 431 formed therein. As shown in FIGS. 5A-5C, the dimensions (i.e. the diameter) of receiving space 431 can be increased during the rolling by adjusting the position of pivotable guide element 434 in order to take into consideration the ever increasing dimensions of the bale (b). Once the rolling has been completed, the unloading door can be opened (FIG. 5D) and the formed bale (b') can be removed from rolling unit 4. In order to keep sufficient tension on the elongate drive elements 423 when opening unloading door 408 the tensioning element 428 pivots forward (see position in FIG. 5D) under the influence of the bias produced by spring 435. This makes the whole discharge opening on the discharge side of the rolling unit available for removal of the bale (b') from rolling unit 4, for instance by catapulting it toward the discharge unit.

As described above, a rolling unit 4 can be embodied with bounding elements for bounding the receiving space 431. It is favourable for these bounding elements to be embodied to form an effective receiving space 431 of a variable size (for example of a size that varies during rolling), so that when different quantities of fibre plants or parts thereof are present, a coherent bale is formed. The variation in the size of the receiving space can also help in limiting the diameter of the formed bale. In the case of relatively short fibre plant parts making the receiving space larger by increasing the intermediate distance between the lateral bounding elements can for instance result in the diameter of the bale remaining relatively small (and the formed bales therefore remaining more readily stackable).

During filling the fibre plants will begin to exert an (ever-increasing) lateral force on the sideways bounding elements (i.e. on the lateral bounding elements) at a certain moment. As soon as the variable receiving space has been sufficiently filled, i.e. as soon as the bale has been rolled into a desired bale diameter, the rolling process stops and the bale can be removed from the rolling unit. Filling of the variable receiving space is here configured such that the rolling process stops in any case when the receiving space has reached a maximum filling, i.e. has been filled to predetermined maximum dimensions, for instance in respect of diameter, and/or to a maximum mass, and/or to a predetermined maximum pressure on the lateral bounding elements. The dimensions (for instance the diameter) of the bale, the pressure on the bale and/or the mass of the bale can be measured during forming of the bale, although in other embodiments the dimensions and/or mass are additionally or alternatively measured after the bale has been removed from the rolling unit, for instance when the bale comes to rest on one of the receiving units.

Supply of fibre plant parts is ended the moment the bale has reached the desired dimensions and/or the desired mass (in the latter case when means have indeed been provided for measuring the mass (weight)). The formed bale can then be unloaded by opening unloading door 408. It is preferred here to briefly increase the mutual distance between the lateral bounding elements so that any tensions built up between the lateral bounding elements and the rolled-up (parts of) fibre plants can be reduced. Not only does this facilitate unloading of the bale of fibre plants, it also reduces the risk of damage to the fibre plants during unloading, whereby seed of the fibre plants could for instance be lost. A further advantage is that when the speed of the belts is increased during tying of the bale (i.e. wrapping with tying materials such as rope) and the friction between the bounding elements and the fibre plant parts thereby essentially greatly increases, which would also greatly increase the risk of losing seed (especially if the fibre plant parts originate from hemp plants) of the fibre plant parts, this friction and the accompanying risk of seed loss can be reduced by increasing the mutual distance between the lateral bounding elements.

The risk of seed loss can also decrease in embodiments in which bounding elements 414 are arranged rotatably on the frame. In these embodiments the lateral bounding elements can co-rotate to greater or lesser extent with the rotating movement of the fibre plants in the receiving space so that there is less friction between the fibre plant parts and the inner side of the lateral bounding elements.

In determined embodiments the rolling unit is provided with one or more moisture sensors 415 configured to determine the degree of humidity inside the receiving space. Referring to FIG. 4C and 4E, in determined embodiments at least one of the lateral bounding elements can be provided with such a moisture sensor 415, for instance by arranging the moisture sensor on the side of a bounding element 414 directed toward the receiving space. The moisture sensor is configured to generate a humidity signal representative of the momentary humidity in the receiving space and transmits this humidity signal to control unit 13. The control unit then determines whether action should be taken on the basis of the degree of humidity, for instance increasing or reducing the mutual lateral distance between the lateral bounding elements and/or the pressure on the elongate drive elements (belts) 423. In determined embodiments action is for instance taken when the degree of humidity exceeds a predetermined threshold value (for example 17%). This action could for instance consist of control unit 13 progressively lowering the pressure of the drive elements (belts) on the fibre plants in the receiving space until the degree of humility drops below said threshold value again.

In determined embodiments the rolling unit is provided with one or more dimension measuring units configured to determine the momentary radial dimension of a bale in the receiving space, to generate a measurement signal representative of the measured radial dimension of the forming or already formed bale, and to transmit it to control unit 13. The radial dimension can be the radius or diameter of the bale. The received measurement signal can for instance be used by the control unit to determine that the supply of fibre plants can be halted (for instance because the desired bale diameter has been reached) so that control unit 13 is able to instruct distributing unit 301 to send the fibre plants to a different rolling unit. Control unit 13 can then decide to start tying the bale. During this tying the bale can be rotated much more quickly. Control unit 13 then controls drive motor 424 to start rotating more quickly. At the same time, the control unit arranges for at least one of the adjusting elements of the lateral bounding elements to increase the mutual distance between the lateral bounding elements in order to prevent excessive friction between the fibre plants and the lateral bounding elements.

In a determined embodiment the dimension measuring unit comprises an angle sensor 451 (shown schematically in FIG. 4C) which measures a momentary angle between the pivotable guide element 434 and the support frame 422 of rolling unit 4. This measured angle is representative of the radial dimensions of the bale applying at that moment.

In a rolling unit 4 for cylindrical bales the unloading door 408 can be configured to open by swinging aside in upward or downward direction, preferably upward. It is advantageous here for unloading door 408 to rotate about rotation shafts 410 which are arranged close to the centre point of the lateral bounding elements 414 (also being the point of rotation of the bounding elements in the embodiment in which the bounding elements are pivotable/rotatable), in other words close to the central position of adjusting elements 416. In determined embodiments the rotation shafts 410 of unloading door 408 lie between 10 cm and 50 cm higher than the centre point of a lateral bounding element 414 (wherein said adjusting elements 416 are located at this centre point). This is because unloading door 408 thereby always remains close to the peripheral edges of the lateral bounding elements 414 during rotation. This has the result that when unloading door 408 is opened, there is less inertia on vehicle chassis 102 and opening can be quicker, and less free space is needed on the unloading side 409 of rolling unit 4, whereby other storage and/or processing units of device 1, for instance a subsequent rolling unit 4, can be placed nearer, enabling a more compact embodiment to be achieved.

In a particularly favourable embodiment unloading door 408 is even configured to swing away to a swing-away position lying inside rolling unit 4, but just outside the effective receiving space 431. It is noted that this is possible in that the effective receiving space 431 gradually changes shape and location when unloading the bale in that swivelling of unloading door 408 causes the corresponding rollers 713 over which belts 423 run to move as well. In this embodiment unloading door 408 preferably moves along the bale on the upper side and to a swing-away position (see FIG. 4F) close to the upper side of the drum.

The inside of the receiving space, i.e. the mutual distance of the two lateral bounding elements 414, is preferably slightly wider than the fibre plant parts to which the rolling unit 4 is adapted. As already stated above, rolling unit 4 is embodied with adjusting elements 416 for adjusting the lateral bounding elements 414, particularly the lateral bounding panels or wings, in the width direction, wherein adjusting comprises of displacing one or both lateral bounding elements, particularly the lateral bounding panels or wings, 414 in the width direction and/or controlling a tension in the direction of the drum of one or both lateral bounding elements, particularly the lateral bounding panels or wings, 414.

This is because, if the panels are adjustable, the width of the bales to be formed can be determined and/or the pressure on the material in receiving space 431 can also be controlled to some extent during operation. A significant advantage hereof is that, when unloading the bale, the pressure on the lateral bounding elements 414, particularly the lateral bounding panels or wings, can be released or greatly reduced so that the bale exits the drum more easily and rapidly and fewer bolls are lost from the fibre plant parts due to vibrating and scraping of the bale during unloading.

Adjusting the positioning of the lateral bounding elements 414 can also be advantageous during the tying at the end of or immediately following the rolling. More particularly, it is advantageous to increase the mutual distance between the lateral bounding elements 414 in order to thus reduce the friction between the fibre plant parts and the bounding elements 414. Not only is this advantageous during rolling of the bale, but (especially) also when tying the bale, since the rolling conveyors run considerably faster during tying than when forming the bale, for instance 2 to 2.5 times faster. Rotating the bale, which at that point has reached its maximum size and therefore has a relatively great deal of friction with the inner side of the drum and with belts 423, is considerably easier with a greater intermediate distance between the lateral bounding elements. Moreover, with a greater intermediate distance fewer bolls are also lost during tying, and less driving power is required.

The rolling unit can for instance be configured to adjust the width by controlling the tension on the lateral bounding elements, particularly the lateral bounding panels or wings, via adjusting elements 416 in the form of the above stated hydraulic extending cylinders (see FIG. 4D) which are arranged centrally on the guide panel, without the need for panels being replaced or permanent reducing elements being arranged in the receiving space 431. The panels can for instance be embodied such that they can be adjusted between 0.8 m and 1.3 m.

Rolling unit 4 can be configured with means for allowing a person to control the tension on and/or the positions of the lateral bounding elements, particularly the lateral bounding panels or wings, in situ, for instance manually. This is however difficult and potentially unsafe during operation of rolling unit 4. It is therefore preferred to provide means to allow the tension and/or position to also or only be controlled remotely, preferably as part of the steering and control units 104 and/or the central control unit 13 (for instance an HMI) in driver's cab 105. Means can also or otherwise be provided to allow the tension and/or position to be controlled automatically, without intervention of a person, on the basis of measurements at rolling unit 4 or the formed bale during operation of the rolling unit.

### Baling—Discharging Formed Bale

A bale (b, b') which is unloaded from a rolling unit 4 can be received by a discharge unit 517 (see particularly FIGS. 11A-11D for a first embodiment and FIGS. 12A-12C and 13A-13B for a second embodiment also provided with an ejecting unit) outside the unloading door 408, preferably a separate, respective discharge unit 517 per rolling unit 4. According to the embodiment of FIGS. 11A-11D, the rolled-up bale (b) finds its way into the discharge unit 517 either indirectly, via a lying receiving plate 525, or directly. Discharge unit 517 can be provided with a barrier 518 (for instance in the form of an upright fence) in order to restrain the widest part of an unloaded bale (b) on the rear side. Discharge unit 517 comprises a receiving part 519, for instance a laterally tiltable carrier, more particularly a dish-shaped carrier, in which carrier a bale (b) coming from rolling unit 4 can be carried in stable manner. This receiving part 519 can be provided with raised edges 520 on both sides in the longitudinal direction of vehicle 101 in order to prevent the cylindrical bale from rolling. Receiving part 519 can be provided with a tipping installation 521 for making receiving part 519 tilt upward from the lying position shown in FIG. 11A into the oblique position shown in FIGS. 11B-11D, and vice versa. The tilting takes place around one or more tilting shafts 522 which form part of the tilting installation 521. The tilting shaft 522 extends substantially parallel to the longitudinal direction of vehicle 101 and is driven by an actuator 521, for instance an electrically and/or hydraulically operated lifting cylinder 526, which is attached to chassis 102 of the vehicle on one side and to receiving part 519 on the other and which forms part of tilting installation 521. An unloaded bale (b) which has found its way directly or indirectly onto discharge unit 517 can thereby be pushed independently to the side of the vehicle and be placed on the above stated bale storage unit 6.

In the alternative embodiment shown in FIGS. 12A-12C and 13A-13B discharge unit 517 comprises instead of or in addition to said lying receiving plate 525 an ejecting unit 530 for ejecting a completed (i.e. sufficiently rolled-up) bale (b) from rolling unit 4 and placing it onto receiving part 519. Ejecting unit 530 is configured to be pivoted between the lying position shown in FIGS. 12A-12C and the upright position shown in FIGS. 13A-13B. By pivoting from the lying position to the upright position a bale (b) can be ejected from rolling unit 4.

In the shown embodiment the ejecting unit 530 comprises two stationary support profiles 531, 532 arranged in longitudinal direction of the vehicle and fixedly on the chassis 102. Each of these stationary support profiles 531, 532 is coupled via a respective hinge 542, 543 to a pivotable frame 535. Arranged on the underside of support profiles 531, 532 are respective actuators 533, 534, for instance the extending cylinders (of hydraulic and/or electric type) shown in the figures, whereby frame 535 is pivotable between said lying position and upright position. Frame 535 comprises a parallelogram arm construction comprising pivotable upper longitudinal arms 538, 539 and lower longitudinal arms 540, 541 pivotable parallel thereto. Each of the upper longitudinal arms 538, 539 is coupled at a first outer end via a first hinge 542, 543 to a stationary support profile 531, 532 and is coupled on an opposite second outer end via a second hinge 560, 561 to further longitudinal arms 544, 545. Arranged between longitudinal arms 538, 539 and further longitudinal arms 544, 545 are transverse profiles 546, 547, 548, these forming together with the longitudinal arms a frame 535 with which a bale (b) can be displaced to receiving unit 517.

Frame 535 can be displaced upward and downward by operating the two actuators 533, 534. Frame 535 is here embodied such that the longitudinal arms 531, 532 pivot relative to the stationary support profiles 531, 532 via the first hinge 542, 543 and the further longitudinal arms 544, 545 pivot relative to longitudinal arms 531, 532 to some extent via hinge 560, 561. The parallelogram arm construction is here preferably embodied such that, in the lying position, the longitudinal arms 538, 539 and the further longitudinal arms 544, 545 extend substantially mutually in line (see FIG. 12A) while, in the upright position, the further longitudinal arms 544, 545 are positioned slightly obliquely relative to the longitudinal arms 538, 539 (i.e. obliquely rearward, in the direction of discharge unit 517). In the upright position (and in intermediate positions between the upright and lying position) the frame 535 defined by longitudinal arms 538, 539 and further longitudinal arms 544, 545 forms as it were a generally concave (hollow) engaging surface which can engage extra well on the convex (spherical) peripheral surface of the bale (b) to be ejected. This reduces the chances of the bale moving upward while being ejected and/or not being received properly by receiving part 519.

In determined embodiments a weighing unit is provided for weighing each of the unloaded bales. In a specific embodiment a weighing unit 569 positioned between receiving part 519 and (a part of the frame of) chassis 102 of the vehicle is provided. Weighing unit 569 is shown schematically in FIGS. 11B, 11C and 11D and comprises at least one of a measuring apparatus 570¹ mounted on the chassis, wherein in lying position of receiving unit 517 the measuring apparatus is in contact with a contact surface 570² provided on the underside of the pivotable receiving part 519. The weighing unit 569 is configured to determine the weight of receiving part 519 with and without a bale (b) placed thereon. The weight (or mass) of each individual bale (varying from bale to bale) can be determined therefrom. Weighing unit 569 is further configured to generate weight data representative of the determined weight (mass) of the bale (b), preferably a weighing signal representative of the weight of the bale, and to then generate this weighing signal or transmit these weight data to the central control unit 13 (after which the weight data may be stored on a storage medium).

In other embodiments a weighing unit is provided in rolling unit 4 itself, this as alternative to or in addition to said weighing unit 569. This weighing unit (not shown in the figures) is configured to generate weight data representative of the weight of a bale when located in the rolling unit 4.

### Tying Material Storage

FIGS. 6A-6C show a tying material storage unit 5 and an upward folding man platform 7 according to an embodiment. FIG. 6D shows a tying material storage unit and man platform according to a second embodiment.

After a bale has been formed and before this bale is unloaded the bale can be tied by wrapping it with tying materials, for instance twine.

When forming bales of fibre plants it is greatly preferred for the tying materials to contain only natural fibres such as sisal, jute, flax, hemp and so on, and no synthetic fibres. It can thus be achieved that the bale remains essentially free of contaminants affecting the fibre quality.

A storage unit 5, in the shown embodiment comprising a twine cabinet which comprises a collection of spools 501, is provided for the tying materials. In the shown embodiments the spools 501 are arranged in horizontal rows 502 which are placed one above the other and are staggered relative to each other in vertical direction. The tying material storage unit 5 is here in each case arranged on the left-hand side of vehicle 101. It will be apparent to the skilled person that this may as well be the right-hand side, as long as tying materials are present close to each rolling unit.

In a first embodiment the tying material storage unit 5 is mounted such that it is displaceable in the height direction between an upper position 503 (FIG. 6A) in which it is situated at essentially the same height as rolling units 4 and close to rolling units 4 so that the tying materials can be made readily available for tying around bales during operation of device 1, and a lower position 504 (FIG. 6B) in which the tying material storage unit 5 is located close to the ground so that when vehicle 101 is stationary, for instance when device 1 is not in operation, a person can replenish the tying materials in the tying material storage unit 5 or perform maintenance and repairs from the ground. In order also to give persons access to one or more storage and/or processing units during travel and optionally operation of device 1, for example for the purpose of access to driver's cab 105, supplying or discharging materials, and/or inspection, maintenance, repairs and assembly, one or more accessibility aid elements can be arranged on vehicle 101.

Firstly, a driver or other person working with or on device 1 can access different parts of device 1, these usually lying relatively high up on vehicle 101, in a manner known in the field, by stepping onto a tyre of vehicle 101. An entering and alighting step 702 (see FIGS. 1A, 16A) and/or collapsible stairs 450 (FIG. 16A) can be provided on at least one side of a driver's cab 105, in this case the left-hand side, for the purpose of making driver's cab 105 accessible.

On the side of vehicle 101 with the bale storage unit 6 a man platform 7 can be provided as accessibility aid element. The shown man platform 7 can be entered 702 via a tyre or directly from the entering and alighting step 702 of driver's cab 105. Such a man platform 7 runs along substantially the whole width of all rolling units 4 and/or also along the tying material storage unit 5. Man platform 7 hereby enables persons to gain easy access to different storage and/or processing units of device 1 present on vehicle 101. Man platform 7 can be arranged in upward folding manner in the same way as a bale storage unit 6 for bales, which will be described below with reference to FIGS. 7A and 7B. Man platform 7 can be provided with a safety railing 701 in order to prevent persons present on man platform 7, optionally during travel of vehicle 101, from falling off device 1.

As alternative to the above stated displaceable mounting of the tying material storage unit 5 (in the embodiment of FIG. 1A), the tying material storage unit 5 is in the embodiment of FIG. 16A mounted such that it is permanently situated in a lower position below man platform 7. FIG. 16A shows a tying material storage unit 5 (the access door of which has been omitted for the sake of clarity of the drawing) which extends in longitudinal direction over almost the whole distance between the wheels and which is therefore able to handle a relatively large capacity (for instance tying material for 100 bales or more). The tying material storage unit 5 of the embodiment of FIG. 16A once again has rows 502 of spools 501 of tying material. Mounting the tying material storage unit 5 at a fixed position necessitates fewer moving parts, which simplifies the device 1 of FIG. 16A. Because the chosen position is relatively low, a person present on man platform 7 will not be hindered in accessing processing units present on vehicle 101. A person is also easily able to access the tying material storage unit 5 from the ground. By selecting a position under man platform 7 the tying material storage unit 5 and man platform 7 need not be adjacent to each other in width direction, which limits the width of device 1 as a whole.

### Bale Storage

FIGS. 7A-7C show a bale storage unit 6 for bales according to an embodiment.

Being able to store one or preferably more bales has the advantage that device 1 can operate continuously for a longer time without having to stop to place bales onto the ground.

It is particularly advantageous if the number of bales that can be stored is high enough to perform one or even two runs across the field from which the swathes are being picked up. In this way all bales can be placed down just at the end of the swathe to be rolled up. This means that the headland remains free to be able to travel thereover. This furthermore has the result that far fewer passes over the field are necessary for follow-up operations, such as discharging the bales. This saves time and prevents unnecessary loading and compaction of the soil. In more detail, this can entail a reduction of the ground pressure. Trucks need no longer drive onto the field, or at least do so to much lesser extent, and the danger of damaging the structure of the field by driving thereon can be reduced. There is also a time saving, since one or more additional persons are normally needed to collect the bales and have them be retrieved.

A typical field depth along which the swathes lie is two kilometres. It has been found that for use of a device 1 in such a field depth a storage capacity of eight to ten bales suffices. Such a capacity can for instance be achieved by making use of a bale storage unit 6 with a capacity of six bales and additionally storing a respective bale on each discharge unit 517 of rolling unit 4, and optionally also a respective bale in each rolling unit 4.

The shown embodiment of a bale storage unit 6 comprises two platforms 601 (particularly platforms 601A, 601B) which are arranged on the right-hand side of vehicle 101. It will be apparent to the skilled person that this may as well be the left-hand side, as long as the different storage and/or processing units arranged on vehicle 101 do not get in each other's way. Because the bale storage unit 6 is arranged on the side of vehicle 101 outside of chassis 102, the bales can be easily set down outside the pass of device 1.

In the embodiment of device 1 according to FIG. 1 the length of platforms 601 is such that the rear platform 601B protrudes at least in horizontal position slightly behind the rearmost point of the rest of device 1. It is however advantageous for the overall length of platforms 601 to be shorter, so that the rearmost platform 601B does not protrude further rearward than the rearmost point of the rest of device 1, this comprising in the shown embodiments the barrier 518 behind discharge unit 517 of rearmost rolling unit 4.

All platforms 601 can be arranged in substantially flat position for the purpose of carrying formed bales thereon. Platforms 601A, 601B can be provided with endless conveyors 602, whereby the bales lying thereon can be displaced over the platforms 601 so as to position them more efficiently and/or transport them away from the bale storage unit 6. The bale storage unit 6 can comprise upright edges 608 (for instance a fence) (shown only partially in FIG. 1B) on the side facing away from vehicle 101 and/or on one or more of the end surfaces in order to prevent bales from falling off the bale storage unit 6.

The device can be provided with a placing unit 605 which is displaceable between a closed position and an open position, wherein in the closed position the bales are held in the bale storage unit 6 and in the open position bales in bale storage unit 6 are placed onto the ground. This displacing unit 606 can be connected to one or more of the discharge units 517 or, more preferably, form part of the bale storage unit 6.

At least the rear platform 601B can be embodied as placing unit 605 by making the rear side rotatable in downward direction to some extent, and preferably to the ground (FIG. 1B) in order to unload bales from the bale storage unit 6 and set them down onto the ground more easily in that they roll or slide off the respective platform more easily. In such an embodiment the downward rotated position of the rear platform 601B corresponds with the open position, and the horizontally rotated position with the closed position.

It will be apparent to the skilled person that more than two platforms 601 can alternatively be provided, with substantially the same action. It is also possible to use only a single platform that can function as placing unit 605 in the manner of said rearmost platform 601B.

Platforms 601 can be embodied to be folded upward so as to considerably reduce the width of vehicle 101. This is advantageous when vehicle 101 is travelling but device 1 is not processing any fibre plant parts, for instance when travelling by public highway. Limiting the width of vehicle 101 can be practically advantageous and/or legally required.

An accessibility aid can be provided on the outer side of the bale storage unit 6, for instance a ladder with one or more rungs, in order to provide access to one of the platforms 601.

FIGS. 8A-8C show schematically different possible placements of rolling units 4 on a device 1. For the sake of clarity some storage and/or processing units have been omitted in some figures.

FIG. 8A shows an embodiment with two rolling units 4 which are placed on a vehicle 101 at different axial positions, in this case one immediately behind the other and essentially in one line. The first rolling unit 4 is placed further forward than the second rolling unit 4 in the axial direction of vehicle 101 (also referred to here as the longitudinal direction L), and at substantially the same transverse position. The two rolling units 4 can be substantially or even wholly identical. This is however not essential, as long as they can both be connected to the same transport unit 3. It is however advantageous for the storage and further processing of formed bales for the formed bales to have substantially the same dimensions and/or the same weight in both rolling units 4.

FIG. 8B shows an embodiment with two rolling units 4 which are placed on a vehicle 101 somewhat offset one behind the other in a lateral direction transversely of the axial direction. The first rolling unit 4 is placed further forward than the second rolling unit 4 as seen in the longitudinal direction L of vehicle 101, but at a position offset in the lateral direction (also referred to herein as the transverse direction D), for instance offset by up to 50 percent of the width of rolling units 4. In such an embodiment at least some of the advantages of the described device 1 can still be achieved.

It is important that rolling units 4 can be powered from the same transport unit 3, this in turn optionally being fed by a plurality of pick-up arms 201, that the width of vehicle 101 can be limited in order to be permitted to travel by public highway without legal restrictions, and/or that the rolling units can have substantially the same construction.

In the embodiments of both FIGS. 8C and 8D the two rolling units 4 are oriented in the same direction: both with unloading side 409 facing rearward. The bales from different rolling units 4 are unloaded onto different discharge units. There are also two separate distributing units 301¹ and 301², wherein each distributing unit is configured to distribute fibre plants coming from a single respective pick-up arm 201¹, 201².

In this embodiment the transport unit 3 can be configured to transport all transported fibre plant parts to the same rolling unit 4 at any individual moment. It is advantageous to stop the supply of fibre plant parts to one rolling unit 4 prior to unloading a bale from this one rolling unit 4, and to supply newly supplied fibre plant parts to the other rolling unit 4, by means of the distributing unit 301. It has been found that unloading a bale and closing the door of the one rolling unit 4 again will take significantly less time than forming a bale in the other rolling unit 4. After unloading and closing again, it is thus safe to switch back to the former rolling unit 4 at any time. In this way it can be ensured that device 1 can operate substantially continuously, i.e. without the unloading of a bale from a rolling unit 4 necessitating other storage and/or processing units of device 1 to pause.

It will be apparent to a skilled person that the shown and described embodiments are only illustrative examples of a general concept within which many variations are possible, while at least some of the discussed advantages are still achieved.

When use is for instance made of two rolling units 4 placed one behind the other, the rear rolling unit 4 can be placed with the unloading side 409 facing forward and the formed bales can optionally be unloaded at the same position as from the front rolling unit 4. This will allow device 1 to be shorter, while the supply from transport unit 3 will only have to be modified in a manner which will be apparent to the skilled person.

In another embodiment it is possible to supply fibre plants or parts thereof to transport unit 3 in a manner other than via a pick-up unit 2, for instance by processing the fibre plants or parts thereof into bales immediately after picking with a picking unit, without placing them on the ground first.

In yet another embodiment it is possible to provide device 1 with two pairs of rolling units 4. This can be two pairs, placed at different positions in longitudinal direction, of rolling units 4 placed wholly or offset one behind the other, for instance two pairs of rolling units 4 placed directly adjacently of each other. Each pair of rolling units 4 can be provided with a respective transport unit 3 and a respective pick-up unit 2 comprising one or more pick-up arms 201. In this way at least some of the described advantages can be achieved while a greater quantity of fibre plants or parts thereof can be rolled up per unit of time by a single device 1 and driver.

In determined embodiments forming a single bale takes between 45 and 90 seconds, for instance 30-40 seconds for filling the receiving space 431 of rolling unit 4, 30-40 seconds for tying, and up to 10 seconds, for instance 5 seconds, for unloading. If it is not necessary to stop once a bale is finished (since a subsequent bale can be worked on immediately and because the finished bale can be stored on the device temporarily), a considerable time saving can be realized.

What is claimed above is defined by the appended claims, within the scope of which numerous modifications can be envisaged.

1. A rolling system for forming a bale from a stream of plants or parts thereof, the rolling system comprising:
a support frame;
a plurality of bounding elements disposed on the support frame to bound a receiving space of variable dimensions, the receiving space receiving and rolling up therein the plants or parts thereof, the bounding elements comprising:
a plurality of parallel lateral bounding elements disposed at a mutual lateral distance to each other to bound the receiving space in a lateral direction, and
one or more radial bounding elements extending substantially in an imaginary peripheral plane to bound the receiving space in radial direction, the one or more radial bounding elements comprising one or more elongate drive elements guided over a plurality of laterally extending rollers;
a drive configured to rotatably drive at least one of the rollers to advance the one or more elongate drive elements, the one or more elongate drive elements being configured in use, when the at least one roller is driven by the drive and the one or more elongate drive elements thereby run, to gradually roll up and form the plants or parts thereof supplied to the receiving space into a bale; and
one or more remotely controllable adjusting elements configured to adjust a lateral position of at least one of the lateral bounding elements.

2. The rolling system according to claim 1, wherein the one or more remotely controllable adjusting elements are configured to adjust the mutual lateral distance between the lateral bounding elements, each of the remotely controllable adjusting elements being configured to adjust one or more of the lateral positions of the lateral bounding elements, and the mutual lateral distance between the lateral bounding elements during rolling, during travel of the vehicle over the ground and simultaneous rolling.

3. The rolling system according to claim 1, further comprising a controller connected to each of the adjusting elements and to an actuator of an unloading door, the controller being configured to adjust one or more of:
(i) the lateral position of at least one of the corresponding lateral bounding elements by controlling at least one of the adjusting elements, and
(ii) a mutual distance between the lateral bonding elements by adjusting the position of one of the lateral bounding elements or by adjusting the positions of both of the lateral bounding elements.

4. (canceled)

5. The rolling system according to claim 3, wherein the controller is configured to one or more of:
(i) keep a mutual distance between the lateral bounding elements substantially the same when adjusting the positions of both of the lateral bounding elements, and
(ii) synchronously and/or continuously adjust the lateral positions of both of the lateral bounding elements.

6. (canceled)

7. The rolling system according to claim 1, further comprising a controller connected to the adjusting elements and at least one of an odometer or position determining system configured to determined a path travelled by the rolling system, the controller being configured to reciprocally displace one of the lateral bounding elements or both of the lateral bounding elements in a lateral direction subject to the travelled path.

8. The rolling system according to claim 1, wherein each of the lateral bounding elements is adjustable in a lateral direction and comprises an adjusting element configured to adjust the lateral position thereof,
wherein one or more of:
(i) the adjusting element is disposed in the center of a respective one of the lateral bounding elements,
(ii) one of the lateral bounding elements is mounted with only a single one of the adjusting elements on the support frame, and.

9. The rolling system according to claim 1, wherein a lateral bounding element is mounted rotatably on the support frame.

10. The rolling system according to claim 1, wherein each of the adjusting elements comprises a remotely controllable actuator configured to adjust the lateral distance between the bounding elements comprises controlling the force being exerted by at least one of the actuators, the remotely controllable actuator being an electric or hydraulic cylinder.

11-12. (canceled)

13. The rolling system according to claim 1, wherein the one or more elongate drive elements are endless drive elements comprising one or more of endless belts and endless conveyors.

14. The rolling system according to claim 1, further comprising a pivotable guide element mounted pivotally on the support frame, a part of the plurality of rollers being mounted rotatably on the pivotable guide element, and
the pivotable guide element is configured to one or more of: (i) move in a radial plane between a respective first position and a second position under pressure of the bale of plants or parts thereof formed gradually in the receiving space to enlarge or change a peripheral form of the receiving space, and (ii) adjust the position of one or more of the rollers mounted on the guide element to radial dimensions of the bale which become increasingly greater during rolling.

15-16. (canceled)

17. The rolling system according to claim 1, further comprising:
a tensioning element mounted pivotally on the support frame and provided with at least one guide roller configured to guide the one or more elongate drive elements; and
a biasing device mounted pivotally on the tensioning element and the support frame to keep the one or more elongate drive elements under bias.

18. The rolling system according to claim 7, further comprising a dimension measuring device configured to determine a momentary radial dimension of a bale in the receiving space to generate a dimension measurement signal representative of the measured radial dimension of the bale and transmitting the generated dimension measurement signal to the controller, the dimension measuring device comprising an angle sensor configured to measure an angle between the support frame and a guide element disposed pivotally on the support frame to obtain the measurement signal that is a signal representative of the measured angle.

19. (canceled)

20. The rolling system according to claim 1, further comprising a moisture sensor which is disposed in one of the receiving space and one of the bounding elements, the moisture sensor being configured to determine a momentary humidity in the receiving space, generate a humidity signal representative of the measured humidity, and transmit the humidity signal to a controller.

21. The rolling system according to claim 18, wherein the controller is configured to control at least one of the adjusting elements based on at least one of the received dimension measurement signal and the received humidity signal to adjust the lateral position of at least one of the lateral bounding elements.

22-23. (canceled)

24. The rolling system according to claim 1, further comprising an unloading door on which at least some of the rollers is mounted, the unloading door being configured to be displaced in a peripheral direction between an opened position to form a discharge opening for a formed bale and a closed position to at least partially close the discharge opening.

25. The rolling system according to claim 1, further comprising:
an unloading door mounted on the support frame via hinges or rotation shafts and pivotable between an opened position and closed position; and
an actuator configured to drive the pivoting between the closed and opened positions,
wherein the hinges or rotation shafts are configured to pivot open the unloading door in an upward direction, and
the unloading door is configured to swing aside to the opened position when the unloading door is opened, along a path lying wholly inside a space spanned by the support frame and just outside the receiving space.

26. The rolling system according to claim 25, wherein the hinges or rotation shafts are disposed close to the center point of the lateral bounding elements and
wherein one or more of: (i) a distance between one of the hinges or rotation shafts on one side and the center point of the respective lateral bounding elements on the other side amounts to between 10 cm and 50 cm, and (ii) one of the hinges or rotation shafts of the unloading door is located above the center point of the relevant lateral bounding elements.

27-28. (canceled)

29. The rolling system according to claim 1, further comprising a supply conveyor configured to supply the stream of plants or parts thereof to the receiving space.

30. The rolling system according to claim 1, wherein the drive comprises one or more of a hydraulic drive and a hydraulic drive motor which is connected via toothed belts to conveyor rollers.

31. The rolling system according to claim 1, further comprising a housing configured to enclose the bounding elements, the housing having a feed opening and an unloading opening.

32. A device for processing plants, the device comprising:
a self-propelling or drawn vehicle comprising a chassis on wheels;
at least one pick-up or picking system, the pick-up or picking system is configured to respectively pick up the plants or plant parts thereof resting on a ground in one or more swathes or pick plants sticking out of the ground;
one or more rolling systems disposed on the chassis according to claim 1; and
a transport system configured to transport the picked-up or picked plants or parts thereof in a stream from the at least one pick-up or picking system, respectively, to at least one of the one or more rolling systems.

33. The device according to claim 32, further comprising a controller configured to reciprocally displace the lateral bounding elements in a lateral direction while the vehicle travels over the ground.

34. (canceled)

35. A method for forming a bale from a stream of plants or parts thereof, by the rolling system according to claim 1, the method comprising:
receiving the stream of plants or parts thereof in the receiving space via a feed opening defined by the elongate drive elements;
driving the rollers in order to run the elongate drive elements, thereby rolling up the plants or parts thereof received in the receiving space;
unloading a formed bale of plants or parts thereof from the rolling system; and
operating one or more of the remotely controllable adjusting elements at least one of before receiving and rolling up the stream of plants, during rolling of the plants, and after rolling of the plants to adjust the lateral position of at least one of the lateral bounding elements.

36-45. (canceled)
